(19) United States
(12) Patent Application Publication
(10) Pub. No.: US 2026/0349816 A1
(43) Pub. Date: Nov. 5, 2026

(54) INFORMATION PROCESSING DEVICE, INFORMATION PROCESSING METHOD, AND RECORDING MEDIUM

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/429,914

(22) Filed: Dec. 22, 2025

(30) Foreign Application Priority Data
Mar. 4, 2025 (JP) 2025-033946
Mar. 4, 2025 (JP) 2025-033959

(51) Int. Cl. G06F 9/50; G07C 5/02

(52) U.S. Cl. CPC G06F 9/5027; G07C 5/02

(57) ABSTRACT

An information processing device is to be provided to a vehicle, and includes a processor and a memory. Using the memory, the processor: determines whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and executes predetermined processing, based on a determination result of whether the total resource amount is greater than the predetermined resource amount.

### CROSS REFERENCE TO RELATED APPLICATIONS

The present application is based on and claims priority of Japanese Patent Application No. 2025-033946 filed on Mar. 4, 2025, and Japanese Patent Application No. 2025-033959 filed on Mar. 4, 2025.

### FIELD

The present disclosure relates to an information processing device to be provided to a vehicle, an information processing method, and a recording medium.

### BACKGROUND

An application is sometimes executed in a vehicle. Patent Literature (PTL) 1 discloses an application management device that monitors a resource consumed by execution of an extended application for implementing an additional function, and stops the extended application while allowing the basic application to continue operating when the used amount of the resource exceeds a predetermined value set as a variable value that depends on the state of the vehicle.

### CITATION LIST

### Patent Literature

PTL 1: Japanese Patent No. 4060322

### SUMMARY

However, the application management device according to PTL 1 can be improved upon.

In view of this, the present disclosure provides, for example, an information processing device capable of improving upon the above related art.

An information processing device according to an aspect of the present disclosure is an information processing device to be provided to a vehicle, the information processing device including: a processor; and a memory, in which, using the memory, the processor: determines whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and executes predetermined processing, based on a determination result of whether the total resource amount is greater than the predetermined resource amount.

An information processing method according to an aspect of the present disclosure is an information processing method to be executed by an information processing device provided to a vehicle, the information processing method including: determining whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and executing predetermined processing, based on a determination result of whether the total resource amount is greater than the predetermined resource amount.

A recording medium according to an aspect of the present disclosure is a non-transitory computer-readable recording medium having recorded thereon a program for causing a computer to execute the information processing method described above.

An information processing device and the like according to an aspect of the present disclosure are capable of improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a vehicle according to Embodiment 1.

FIG. 2 is a diagram for describing resource amounts according to Embodiment 1.

FIG. 3 is a flowchart illustrating installation processing by an app control device according to Embodiment 1.

FIG. 4 is a flowchart illustrating app control processing by an app control device according to Embodiment 1.

FIG. 5 is a block diagram illustrating a configuration of an information processing device according to Embodiment 1.

FIG. 6 is a flowchart illustrating an information processing method according to Embodiment 1.

FIG. 7 is a block diagram illustrating a configuration of a vehicle according to Embodiment 2.

FIG. 8 is a flowchart illustrating installation processing by an app control device according to Embodiment 2.

FIG. 9 is a flowchart illustrating app control processing by an app control device according to Embodiment 2.

FIG. 10 is a block diagram illustrating a configuration of an information processing device according to Embodiment 2.

FIG. 11 is a flowchart illustrating an information processing method according to Embodiment 2.

FIG. 12 is a block diagram illustrating a configuration of an information processing device according to Embodiment 3.

FIG. 13 is a flowchart illustrating an information processing method according to Embodiment 3.

### DESCRIPTION OF EMBODIMENTS

### Overview of the Present Disclosure

Hereinafter, techniques derived from the content of the disclosure of the present specification will be described by way of example, and the effects and the like derived from such techniques will be described.

Technique 1 is an information processing device to be provided to a vehicle, the information processing device including: a processor; and a memory, in which, using the memory, the processor: determines whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and executes predetermined processing, based on a determination result of whether the total resource amount is greater than the predetermined resource amount.

According to this technique, the possibility of unexpected processing being executed by the user application can be reduced, and the resource included in the vehicle can be efficiently used so that the resource does not become unnecessarily idle. Therefore, the execution of the application in the vehicle can be further improved.

Technique 2 is the information processing device according to Technique 1, in which when the total resource amount is determined to be greater than the predetermined resource amount, the processor executes reduction processing that reduces a resource amount allocated to the user application being executed, to be less than the first resource amount.

According to this technique, it can be determined whether a resource amount greater than the resource amount that would be allocated to the user application when the user application normally operates (that is, without any problem) is requested by the user application. When a resource amount greater than the resource amount that would normally be allocated to the user application is requested by the user application, the possibility that a failure occurs in the user application is high. Therefore, the information processing device according to Technique 1 determines the resource amount to be allocated to each of one or more user applications used in the vehicle based on a predetermined resource amount (that is, a predetermined threshold) specified for the user application. Specifically, when the total resource amount is determined to be greater than the predetermined resource amount specified for the user application, the information processing device according to Technique 1 reduces the resource amount allocated to the user application being executed. That is, when the possibility of unexpected processing being executed by the user application is high, the processing amount of the user application is reduced. Accordingly, the possibility of unexpected processing being executed by the user application can be reduced. Therefore, the safety of the vehicle in the case where the user application is used in the vehicle can be improved.

Technique 3 is the information processing device according to Technique 2, in which in executing the reduction processing, the processor executes stop processing that stops processing of the user application being executed.

According to this technique, processing executed by the user application being executed is stopped, so that the safety of the vehicle in the case where the user application is used in the vehicle is improved.

Technique 4 is the information processing device according to any one of Techniques 1 to 3, in which when the total resource amount is determined to be less than or equal to the predetermined resource amount, the processor causes first processing to be executed by the user application, and when the total resource amount is determined to be greater than the predetermined resource amount, the processor executes second processing that causes the first processing to be executed with a delay.

According to this technique, even when a resource amount greater than the resource amount that would be allocated to the user application when the user application normally operates (that is, without any problem) is requested by the user application, the first processing is executed with a delay compared with the case where the first processing is immediately executed using the requested resource amount of resource. In the second processing, for example, the first processing is executed using a resource less than the requested resource amount. Furthermore, in the second processing, for example, the timing of starting the first processing is delayed by a predetermined period. Conventionally, when a resource amount exceeding a predetermined threshold is requested by the user application, the processing corresponding to the request is not executed. In such a case, therefore, the user application is stopped, or the user application repeatedly outputs information requesting for the resource. In this regard, the information processing device according to Technique 1 causes the first processing to be executed with a delay when the total resource amount is determined to be greater than the predetermined resource amount. Accordingly, the user application can be prevented from being kept stopped. Furthermore, since the first processing is executed without information requesting the resource being repeatedly output from the user application, the processing amount of the user application can be reduced. Furthermore, since the first processing is executed without information requesting the resource being repeatedly output from the user application, since the first processing is executed without information requesting the resource being repeatedly output from the user application, when the first processing is immediately executed after a predetermined period elapses or when there is an available resource that is not used by other apps, for example, if there is a process that can be executed earlier than the other processes in the first processing, a part of the first processing is executed earlier. Therefore, compared with the case where information requesting for the resource is repeatedly output from the user application and the first processing is executed when such information is obtained, the timing of completion of the first processing executed when the total resource amount is determined to be greater than the predetermined resource amount can be advanced. Therefore, the information processing device and the like according to Technique 1 can efficiently execute the user application in the vehicle.

Technique 5 is the information processing device according to Technique 4, in which in the second processing, the processor: calculates a predetermined period, based on the total resource amount; and causes the first processing to be executed based on the predetermined period.

According to this technique, at a timing when the amount of resource requested by the user application becomes available, the first processing can be executed using the amount of resource requested by the user application.

Technique 6 is the information processing device according to Technique 5, in which in the second processing, the processor causes the first processing to be executed after the predetermined period elapses from when the second resource amount is requested by the user application.

According to this technique, at a timing when the amount of resource requested by the user application becomes available, the first processing can be executed using the amount of resource requested by the user application.

Technique 7 is the information processing device according to Technique 5, in which in the second processing, the processor: determines whether a predetermined vehicle resource included in the vehicle is allocated for execution of an other application until the predetermined period elapses from when the second resource amount is requested by the user application; when the predetermined vehicle resource is determined to be allocated for execution of the other application, does not cause the first processing to be executed until the predetermined period elapses from when the second resource amount is requested by the user application; and when the predetermined vehicle resource is determined not to be allocated for execution of the other application, causes the first processing to be executed using the predetermined vehicle resource.

For example, when the total resource amount is determined to be greater than the predetermined resource amount for a user application, the priority of the user application in using the resource is set to be lower than the other applications of a plurality of applications included in the vehicle. If the priority is set to be lower, for example, when the resource included in the vehicle is determined to be allocated for execution of another application, the resource is not allocated to the user application but is preferentially allocated to the other application so that processing of the other application is preferentially executed. On the other hand, when there is an available resource in the vehicle, the first processing is executed using the resource. Therefore, the resource included in the vehicle can be efficiently used so that the resource does not become unnecessarily idle.

Technique 8 is the information processing device according to any one of Techniques 5 to 7, in which in calculating the predetermined period, the processor calculates the predetermined period, based on the first resource amount per unit time, the second resource amount, and the predetermined resource amount per unit time.

According to this technique, the timing when the amount of resource requested by the user application becomes available can be calculated.

Technique 9 is the information processing device according to any one of Techniques 1 to 8, in which the processor: obtains state information indicating a state of the vehicle; and in determining whether the total resource amount is greater than the predetermined resource amount, uses, as the predetermined resource amount, a resource amount corresponding to the state of the vehicle indicated by the state information among a plurality of resource amounts specified in advance for a plurality of states of the vehicle.

Depending on the type of the user application, the resource amount required for execution may vary with the state of the vehicle. In view of this, a predetermined resource amount is selected from among a plurality of resource amounts according to the state of the vehicle and used for the determination described above, so that whether the possibility of unexpected processing being executed by the user application is high can be correctly determined in the determination described above.

Technique 10 is the information processing device according to Technique 9, in which the state information includes at least one of information indicating whether the vehicle is traveling or information indicating whether the vehicle is parked.

According to this technique, when the resource amount required for execution of the user application varies depending on whether the vehicle is traveling and whether the vehicle is parked, in the determination of whether the total resource amount is greater than the predetermined resource amount, the possibility of unexpected processing being executed by the user application can be correctly determined.

Technique 11 is the information processing device according to any one of Techniques 1 to 10, in which the user application is an application different from an application preinstalled in the vehicle.

According to this technique, the safety of the vehicle in the case where an application different from applications preinstalled in the vehicle is used in the vehicle can be improved.

Technique 12 is an information processing method to be executed by an information processing device provided to a vehicle, the information processing method including: determining whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and executing predetermined processing, based on a determination result of whether the total resource amount is greater than the predetermined resource amount.

According to this technique, the same effects as those of the information processing device according to Technique 1 are achieved.

Technique 13 is a program for causing a computer to execute the information processing method according to Technique 12.

According to this technique, the same effects as those of the information processing device according to Technique 1 are achieved.

Hereinafter, exemplary embodiments will be specifically described with reference to the accompanying drawings.

Note that each of the exemplary embodiments described below shows a general or specific example. The numerical values, shapes, constituent elements, the arrangement and connection of the constituent elements, steps, the processing order of the steps etc. shown in the following exemplary embodiments are mere examples, and therefore do not intend to limit the present disclosure. Furthermore, among the constituent elements in the following exemplary embodiments, those not recited in any of the independent claims are described as optional constituent elements.

Note also that the drawings are represented schematically and are not necessarily precise illustrations. Thus, the scales of the drawings, for example, are not necessarily precise. In the drawings, essentially the same constituent elements share the same reference signs, and redundant descriptions will be omitted or simplified.

Also, in the present specification, numerical values and numerical value ranges do not express their strict meanings only, but also include substantially equivalent ranges, e.g., differences of several percent (or approximately 10%), as well.

Further, in the present specification, ordinal numerals such as “first” and “second” do not mean the number or order of constituent elements, unless otherwise stated in particular. The ordinal numerals are used to avoid confusion of and distinguish between constituent elements of the same type.

### Embodiment 1

### Underlying Knowledge Forming Basis of the Present Embodiment

It is expected that in the future, users will be able to arbitrarily introduce a user application to a vehicle to add, to the vehicle, a function executable by the vehicle. That is, it is expected that the authority to control devices (referred to also as resources) included in the vehicle, such as an electronic control unit (ECU), a display, and lighting equipment, is granted to user applications. For example, the authority to control a vehicle resource is expected to be granted to user applications, provided that the function is not directly linked to the life of the passengers of the vehicle.

A user application is an application used by a user in a vehicle. The user application is introduced to (specifically, installed in) the vehicle by the user and used by the user in the vehicle. The user application is an application that controls a vehicle resource to be controlled by the basic application preinstalled in the vehicle instead of the basic application or in cooperation with the basic application.

When such a user application is used, the vehicle resource is desirably safely controlled by the user application. When the vehicle resource is controlled by the user application, that is, during execution of the user app, if a failure of the user application occurs, unexpected operation of the vehicle resource may occur. Furthermore, when the user application is under attack that can cause a safety problem (referred to also as a security attack), such as cyberattack, the user application may exhibit an abnormal behavior.

Such failures of user applications or security problems are desirably correctly and quickly detected and coped with.

However, when the amount of the resource used by the user application is acceptable for the vehicle as a whole and only whether the resource amount is acceptable is determined for each state of the vehicle as described in PTL 1, for example, it cannot be correctly determined whether the behavior of the user application is an abnormal behavior caused by a failure or a security attack. That is, whether an anomaly is occurring in the user application cannot be correctly determined only by determining whether the resource amount allocated to the user application is less than or equal to the permitted resource amount specified by taking the resource amount of all the resources included in the vehicle (all the vehicle resources including an ECU, for example) into consideration. Therefore, a failure of the user application or a security problem is not correctly detected only by such determination.

In view of this, the inventor has devised the present embodiment.

In other words, if a failure occurs in an application (referred to also as a user application) used by a user, such as a driver, in a vehicle, a problem with the safety of the vehicle may occur.

The present embodiment provides an information processing device and the like that can improve the safety of a vehicle in the case where a user application is used in the vehicle.

### Configuration

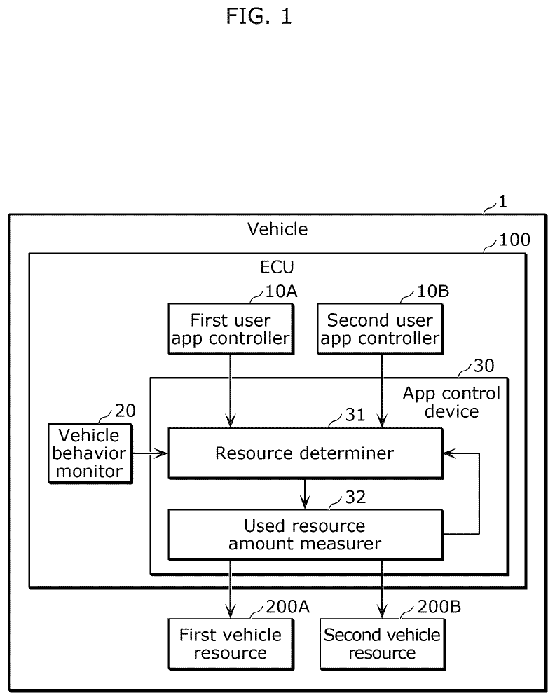

FIG. 1 is a block diagram illustrating a configuration of vehicle 1 according to Embodiment 1.

Vehicle 1 is a vehicle such as an automobile or a motorcycle. Vehicle 1 includes ECU 100, first vehicle resource 200A, and second vehicle resource 200B. Note that the number of vehicle resources of vehicle 1 is not limited to 2 and can be any number equal to or greater than 1.

ECU 100 is an onboard ECU provided to vehicle 1 and executes control of the resources of vehicle 1. ECU 100 is a device that includes a digital circuit such as a processor (microprocessor) and a memory, an analog circuit, and a communication circuit, for example. The memory is implemented as a read only memory (ROM) or a random access memory (RAM), for example. The memory stores a control program (computer program) to be executed by the processor. For example, the processor operates according to the control program (computer program) to make ECU 100 implement various functions. The control program includes a user application (user app), for example. ECU 100 may include a storage device, such as a semiconductor memory or a hard disk drive (HDD).

Note that the application (application program) is also referred to simply as app. For example, the user application is also referred to simply as user app, and the basic application is also referred to simply as basic app.

The user app is an app different from the basic app preinstalled in vehicle 1, for example. The user app may be an app that is made executable by an operation by (or a contract to) a user or an app installed by a user, for example. The user app may be an app that can execute a function that is more advanced than functions that can be executed by the basic app, for example.

Examples of the user app include an entertainment app that uses only a resource for outputting sound, such as audio equipment, when vehicle 1 is traveling and uses not only audio equipment but also other resources, such as a display device and a room lamp, when vehicle 1 is stopped. Examples of the user app further include an autonomous parking app that uses only resources such as the driving mechanism such as the engine for controlling the traveling of vehicle 1 and a camera for taking images of the surroundings of vehicle 1 during autonomous parking of vehicle 1 and uses only recourses such as a microphone for recognizing the voice of the user that causes vehicle 1 to autonomously park at any time other than during autonomous parking of vehicle 1. The user app may be an app that uses different amounts of resources depending on the state of vehicle 1, for example.

Resource means a device that is included in vehicle 1 and can be used by a user app. Examples of the resource include a processor and a memory. Resource amount means the capacity of a central processing unit (CPU) included in vehicle 1, the capacity of a dynamic random access memory (DRAM), the bandwidth of the DRAM, the capacity of a storage, the bandwidth of the storage, the transfer volume in a network, and the bandwidth in the network, for example.

Note that the resource may be onboard equipment included in vehicle 1, such as lighting equipment, a display device, or an air conditioner. First vehicle resource 200A and second vehicle resource 200B are specific examples of the resources included in vehicle 1.

Furthermore, a plurality of ECUs are provided to vehicle 1. For example, the plurality of ECUs can communicate with each other over an onboard communication network (more specifically, buses to which the ECUs are connected). At least one of the plurality of ECUs has to have the configuration of ECU 100 illustrated in FIG. 1.

Furthermore, ECU 100 may be an ECU that is disposed in vehicle 1 and controls a resource in a region in which ECU 100 is disposed (the so-called zone ECU) or a central ECU that integrates a plurality of ECUs (the so-called integrated ECU). The integrated ECU is an ECU that integrates functions conventionally distributed among a plurality of ECUs in order to solve problems of the development time and cost increasing as the onboard system becomes complicated, to which the virtualization technology is applied for making one ECU operate as a plurality of virtual computers (virtual machines).

When the user app installed in vehicle 1 is executed, ECU 100 serves as control equipment that controls a device included in vehicle 1. ECU 100 includes first user app controller 10A, second user app controller 10B, vehicle behavior monitor 20, and app control device 30.

Note that the number of user apps of ECU 100 is not limited to 2 and can be any number equal to or greater than 1.

Furthermore, ECU 100 has a basic app (not shown). The basic app may be included in the control program described above. Furthermore, ECU 100 may further include a processing unit that executes the basic app.

Each of first user app controller 10A and second user app controller 10B is a processing unit that executes a user app. In the present embodiment, first user app controller 10A is a processing unit that executes a first user app, and second user app controller 10B is a processing unit that executes a second user app. The first user app and the second user app are examples of the user app installed in vehicle 1 by the user.

The user app is an app created by a party other than the manufacturer of the basic app. Each of first user app controller 10A and second user app controller 10B, for example, executes a user app to control a resource included in vehicle 1. Specifically, each of first user app controller 10A and second user app controller 10B, for example, executes a user app to control onboard equipment using a resource included in vehicle 1.

Each of first user app controller 10A and second user app controller 10B outputs, to app control device 30, information that requests control of a resource included in vehicle 1, and controls a vehicle device when permitted by app control device 30. When executing the first user app, first user app controller 10A outputs, to app control device 30, requested resource amount information that indicates the resource amount required for executing the user app (information that indicates the kind of the resource required for executing the user app and the resource amount, for example). When first user app controller 10A obtains, from app control device 30 as a response to the requested resource amount information, permission information that indicates execution of the first user app is permitted, first user app controller 10A executes the first user app using the resource amount of resource, thereby controlling the onboard equipment.

Note that first user app controller 10A and second user app controller 10B may be apps that use different resources or apps that use a common resource. For example, first user app controller 10A may control first onboard equipment using first vehicle resource 200A, and second user app controller 10B may control second onboard equipment different from the first onboard equipment using second vehicle resource 200B.

In the following, a process common to first user app controller 10A and second user app controller 10B may be described by using the term “user app controller”.

Vehicle behavior monitor 20 is a processing unit that has a function of monitoring the behavior of vehicle 1 and monitors the state of vehicle 1 including the behavior of vehicle 1. For example, vehicle behavior monitor 20 monitors the state of vehicle 1 by obtaining sensing data from a plurality of sensors (not shown) provided to vehicle 1.

The examples of the plurality of sensors include a velocity sensor, an acceleration sensor, a position sensor (a global positioning system (GPS) sensor, for example), a steering angle sensor, a camera, an obstacle sensor, and/or an illuminance sensor.

Note that the plurality of sensors are not limited to these sensors, and any kind of sensors can be used as the plurality of sensors. Furthermore, the camera may be a camera that takes an image of the interior of vehicle 1 or a camera that takes an image of the outside of vehicle 1. Furthermore, the obstacle sensor may be a sensor that detects an obstacle in the surroundings of vehicle 1 by light detection and ranging (LiDAR), for example. However, the obstacle sensor is not limited to this and can be any sensor that detects an obstacle in the surroundings of vehicle 1 in any manner. Furthermore, the illuminance sensor may measure the illuminance inside vehicle 1 or measure the illuminance outside vehicle 1.

Vehicle behavior monitor 20 obtains, from the plurality of sensors as state information indicating the state of vehicle 1, information indicating at least one of the velocity of vehicle 1, the position of vehicle 1, the steering angle of vehicle 1, the travel direction of vehicle 1, or the surrounding environment of vehicle 1. Vehicle behavior monitor 20 outputs the obtained state information to resource determiner 31.

Furthermore, based on the velocity of vehicle 1 indicated by the state information, vehicle behavior monitor 20 may determine whether vehicle 1 is traveling, whether vehicle 1 is traveling at low velocity, whether vehicle 1 is traveling at high velocity, and/or whether vehicle 1 is stopped. Furthermore, for example, vehicle behavior monitor 20 may obtain, as the state information, information indicating the result of these determinations. That is, vehicle behavior monitor 20 may obtain, as the state information, information indicating whether vehicle 1 is traveling. In other words, the state information includes information indicating whether vehicle 1 is traveling, for example.

Note that traveling at low velocity means a state where vehicle 1 is traveling at a velocity lower than a predetermined threshold. On the other hand, traveling at high velocity means a state where vehicle 1 is traveling at a velocity equal to or higher than the predetermined threshold. The predetermined threshold can be arbitrarily specified in advance and is not particularly limited. Information indicating the predetermined threshold is stored in advance in, for example, the memory included in ECU 100.

Furthermore, based on the position of vehicle 1 indicated by the state information, vehicle behavior monitor 20 may determine whether vehicle 1 is traveling at a predetermined location or in a predetermined area. Furthermore, for example, vehicle behavior monitor 20 may obtain, as the state information, information indicating the result of the determination. The predetermined location and the predetermined area can be arbitrarily specified in advance and are not particularly limited. A map and information indicating the predetermined location and the predetermined area are stored in advance in the memory included in ECU 100.

Furthermore, based on the position of vehicle 1 indicated by the state information, vehicle behavior monitor 20 may determine whether vehicle 1 is passing through an intersection and/or whether vehicle 1 is crossing a crosswalk. Furthermore, for example, vehicle behavior monitor 20 may obtain, as the state information, information indicating the result of the determination.

Furthermore, based on the steering angle of vehicle 1 indicated by the state information, vehicle behavior monitor 20 may determine whether vehicle 1 is traveling on a curve (whether vehicle 1 is turning left or right or not, for example) and/or whether vehicle 1 is traveling straight. Furthermore, for example, vehicle behavior monitor 20 may obtain, as the state information, information indicating the result of the determination.

Furthermore, based on the travel direction of vehicle 1 indicated by the state information, vehicle behavior monitor 20 may determine whether vehicle 1 is traveling forward or backward. Furthermore, for example, vehicle behavior monitor 20 may obtain, as the state information, information indicating the result of the determination.

Furthermore, based on the illuminance value of the illuminance sensor indicated by the state information, vehicle behavior monitor 20 may determine whether the surroundings of vehicle 1 are dark. Furthermore, for example, vehicle behavior monitor 20 may obtain, as the state information, information indicating the result of the determination.

Furthermore, vehicle behavior monitor 20 may obtain information indicating whether vehicle 1 is parked. For example, vehicle behavior monitor 20 may determine whether vehicle 1 is parked (in a parking mode) based on the position of the shift lever indicated by the state information. Furthermore, for example, vehicle behavior monitor 20 may obtain, as the state information, information indicating the result of the determination. In other words, the state information includes information indicating whether vehicle 1 is parked, for example.

Note that the state information may include information indicating whether vehicle 1 is being parked by autonomous driving. Vehicle 1 may be capable of autonomous driving or may be remotely controlled. Vehicle behavior monitor 20 may obtain information indicating whether vehicle 1 is driving autonomously, for example.

Furthermore, vehicle behavior monitor 20 may obtain, as the state information, information indicating a current travel mode of vehicle 1. Examples of the travel mode include an autonomous driving mode and a mode of traveling by following another vehicle under adaptive cruise control (ACC), for example.

The parking mode may be included in the travel mode. Vehicle behavior monitor 20 may obtain, as the state information, whether vehicle 1 is driving autonomously and/or whether vehicle 1 is operating under ACC. Furthermore, for example, vehicle behavior monitor 20 may obtain, as the state information, information indicating the result of these determinations.

As described above, the state information may include information indicating whether vehicle 1 is traveling, whether vehicle 1 is traveling at a predetermined location or in a predetermined area, whether vehicle 1 is passing through an intersection, and whether vehicle 1 is parked, for example.

App control device 30 is a processing unit that controls (manages) an app provided in vehicle 1. App control device 30 controls installation of a user app to vehicle 1 or controls execution of a user app installed in vehicle 1, for example. App control device 30 determines whether to permit the user app controller (first user app controller 10A and/or second user app controller 10B in the present embodiment) to install or execute a user app.

App control device 30 includes resource determiner 31 and used resource amount measurer 32.

Resource determiner 31 is a processing unit that determines whether a total resource amount that is a sum of a used resource amount allocated to a user app being executed in vehicle 1 and a requested resource amount requested by the user app being executed is greater than a permitted resource amount specified for the user app. For example, when the requested resource amount is increased, that is, an increased amount of resource is requested by the user app controller executing the user app, or in other words, requested resource amount information indicating the requested resource amount is obtained from the user app controller, resource determiner 31 determines whether the total resource amount of the used resource amount used by the user app executed in vehicle 1 and the requested resource amount is greater than the permitted resource amount specified for the user app.

Resource determiner 31 obtains used resource amount information from used resource amount measurer 32, for example. Furthermore, resource determiner 31 obtains requested resource amount information indicating the requested resource amount from the user app controller, for example. The used resource amount is an example of a first resource amount, and the used resource amount information is an example of first resource amount information. The requested resource amount is an example of a second resource amount, and the requested resource amount information is an example of second resource amount information.

For each of a plurality of user apps, a permitted resource amount is specified in advance. When resource determiner 31 obtains requested resource amount information, for example, resource determiner 31 determines whether the total resource amount is greater than the permitted resource amount based on the permitted resource amount specified for the user app being executed by the user app controller that has output the requested resource amount information.

Information indicating the permitted resource amount specified for each of the plurality of user apps is stored in advance in the memory included in app control device 30, for example. The permitted resource amounts specified for the plurality of user apps may be the same or different, and are not particularly limited. The permitted resource amount is an example of a predetermined resource amount.

When the total resource amount is determined to be greater than the permitted resource amount, for example, resource determiner 31 executes reduction processing that reduces the resource amount allocated to the user app being executed to be less than the used resource amount. That is, when the total resource amount is determined to be greater than the permitted resource amount, resource determiner 31 reduces the processing amount of the user app being executed in the reduction processing. That is, resource determiner 31 reduces the processing amount of the user app controller. In executing the reduction processing, for example, resource determiner 31 executes stop processing that stops processing of the user app being executed. For example, resource determiner 31 outputs, to the user app controller, information indicating to stop execution of the user app to stop execution of the user app by the user app controller. In the reduction processing, resource determiner 31 may cause the processing to be executed with a reduced resource amount allocated for execution of the user app. That is, resource determiner 31 may allow the user app controller to continue executing the user app with a reduced processing amount.

On the other hand, when the total resource amount is determined to be less than or equal to the permitted resource amount, for example, resource determiner 31 allocates the requested resource amount of resource to the user app. This allows the user app controller to continue executing the user app by using the total resource amount of resource.

Note that when total resource amount is determined to be greater than the permitted resource amount, resource determiner 31 may block access to the resource by the user app controller having transmitted the requested resource amount information or may reduce the priority of the access to the resource by the user app controller. Priorities are specified in advance for the plurality of user apps, for example. When resource determiner 31 obtains requested resource amount information from a plurality of user app controllers executing a plurality of user apps, resource determiner 31 determines whether to permit execution of each of the plurality of user apps based on the priorities specified for the plurality of user apps. That is, when resource requests from a plurality of user apps occur, resource determiner 31 determines whether to permit access to the resource by each of the plurality of user apps based on the priority specified for the user app. For example, when a plurality of user apps request to access the same resource, resource determiner 31 permits only the user app having the highest priority to access the resource.

Note that the priorities can be arbitrarily specified in advance and are not particularly limited. Information indicating the priorities is stored in advance in the memory included in app control device 30. Furthermore, the extent of the reduction of the priority of the user app can be arbitrarily determined and is not particularly limited. For example, when the total resource amount is determined to be greater than the permitted resource amount, resource determiner 31 may reduce the priority of the user app to be the lowest among the plurality of user apps included in vehicle 1.

Furthermore, for each of the plurality of user apps, a permitted resource amount that depends on the state of vehicle 1 may be specified in advance. For example, for each of the plurality of user apps, a permitted resource amount in the case where the state of vehicle 1 is traveling and a permitted resource amount in the case where the state of vehicle 1 is stopped are specified. Furthermore, for example, for each of the plurality of user apps, a permitted resource amount in the case where the state of vehicle 1 is parked and a permitted resource amount in the case where the state of vehicle 1 is not parked are specified. For example, resource determiner 31 obtains state information indicating the state of vehicle 1, and in determining whether the total resource amount is greater than the permitted resource amount, resource determiner 31 uses, as the permitted resource amount, the resource amount corresponding to the state of vehicle 1 indicated by the state information among a plurality of resource amounts specified in advance according to the state of vehicle 1. That is, resource determiner 31 determines whether the total resource amount is greater than the permitted resource amount corresponding to the state of vehicle 1. The state information is obtained from vehicle behavior monitor 20, for example.

When all the determination results for different states of vehicle 1 show that the total resource amount is less than or equal to the permitted resource amount, resource determiner 31 permits execution of the user app using the requested resource amount. Otherwise, resource determiner 31 executes the reduction processing.

Used resource amount measurer 32 is a processing unit that obtains used resource amount information. Used resource amount measurer 32 obtains used resource amount information indicating the used resource amount by measuring the used amount of each resource included in vehicle 1 by the user app. Specifically, used resource amount measurer 32 obtains the used resource amount information indicating the used resource amount by obtaining information indicating the user app being executed from each resource (first vehicle resource 200A and second vehicle resource 200B in the present embodiment) included in vehicle 1.

Note that the used resource amount may be a resource amount used per unit time or an accumulated value of the used resource amount. The unit time can be arbitrarily specified and is not particularly limited.

Furthermore, resource determiner 31 determines whether to permit installation of a user app, for example. For example, when resource determiner 31 obtains required resource amount information indicating a user app and a resource amount (required resource amount) required for executing the user app via a radio communication interface included in app control device 30, resource determiner 31 determines whether or not the required resource amount is less than or equal to the resource amount (remaining resource amount) that is available in vehicle 1. When the required resource amount is determined to be less than or equal to the remaining resource amount, resource determiner 31 permits installation of the user app. For example, resource determiner 31 causes the user app controller to execute installation of the user app. On the other hand, when the required resource amount is determined to be greater than the remaining resource amount, for example, resource determiner 31 does not permit installation of the user app and prevents installation of the user app.

Resource determiner 31 calculates the remaining resource amount based on an overall resource amount (overall resource amount) in vehicle 1 and the used resource amount being used in vehicle 1, for example.

Overall resource amount information indicating the overall resource amount is stored in advance in the memory included in app control device 30, for example.

Note that the required resource amount information may include information indicating a required resource amount corresponding to the state of vehicle 1. For example, the required resource amount information may include information indicating a resource amount in the case where vehicle 1 is traveling and information indicating a resource amount in the case where vehicle 1 is stopped. Furthermore, the overall resource amount information may include information indicating a resource amount corresponding to the state of vehicle 1. For example, resource determiner 31 may determine whether or not the required resource amount is less than or equal to the remaining resource amount for each state of vehicle 1. For example, when all the determination results for different states of vehicle 1 show that the required resource amount is less than or equal to the remaining resource amount, resource determiner 31 permits installation of the user app. Otherwise, resource determiner 31 does not permit installation of the user app.

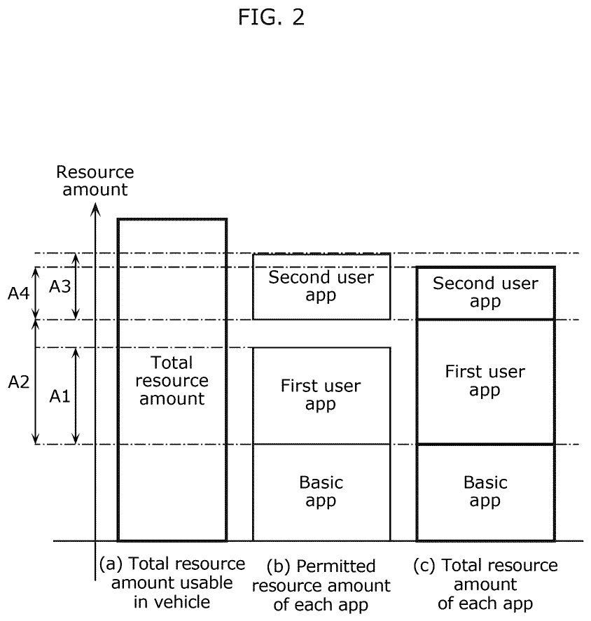

FIG. 2 is a diagram for describing resource amounts according to Embodiment 1. Part (a) of FIG. 2 is a diagram schematically illustrating the overall resource amount of vehicle 1, part (b) of FIG. 2 is a diagram schematically illustrating the permitted resource amount for each app, and part (c) of FIG. 2 is a diagram schematically illustrating the total resource amount for each app.

The remaining resource amount is the difference between the overall resource amount and the used resource amount, for example. The permitted resource amount is the same resource amount as the required resource amount indicated by the required resource amount information obtained along with the user app when the user app is installed, for example.

In the example illustrated in FIG. 2, for example, the permitted resource amount for a first user app is A1, and the total resource amount for the first user app is A2. In this case, resource determiner 31 executes the reduction processing for the first user app, since A1<A2. Resource determiner 31 stops the processing of the first user app being executed, for example.

Furthermore, in the example illustrated in FIG. 2, the permitted resource amount for a second user app is A3, and the total resource amount for the second user app is A4, for example. In this case, resource determiner 31 permits the second user app to use the requested resource.

Each of the processing units included in ECU 100, such as first user app controller 10A, second user app controller 10B, vehicle behavior monitor 20, resource determiner 31, and used resource amount measurer 32, is implemented by a processor and a memory that stores a control program to be executed by the processor. Furthermore, each processing unit may include a radio communication interface including a radio communication circuit and an antenna for obtaining (downloading) a user app.

First vehicle resource 200A and second vehicle resource 200B are resources communicatively connected to ECU 100 by an onboard communication network. First vehicle resource 200A and second vehicle resource 200B are physical devices provided to vehicle 1, for example. First vehicle resource 200A and second vehicle resource 200b are implemented by a processor and/or a memory, for example.

First vehicle resource 200A and second vehicle resource 200B are used for executing a user app, for example, and control onboard equipment, such as lighting equipment including a headlight, a display device, a digital mirror, a room lamp, a power window, an air conditioner, a lock, and/or audio equipment.

Note that first vehicle resource 200A and second vehicle resource 200B may control common onboard equipment or different onboard equipment.

Furthermore, first vehicle resource 200A and second vehicle resource 200B may be used for executing a user app or may be used for executing the basic app. Furthermore, first vehicle resource 200A and second vehicle resource 200B may be used for other processing than processing of an app executed in vehicle 1.

Furthermore, first vehicle resource 200A and second vehicle resource 200B may be the onboard equipment described above.

### Processing Procedure

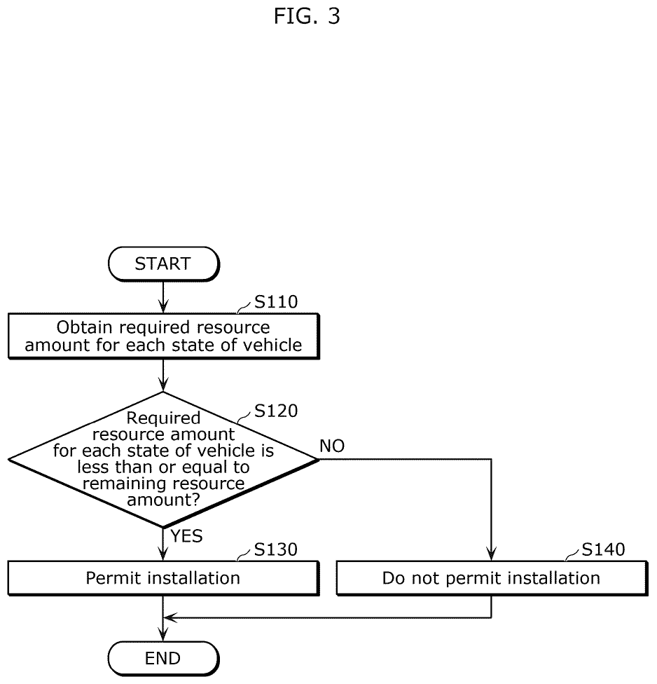

FIG. 3 is a flowchart illustrating installation processing by app control device 30 according to Embodiment 1.

First, app control device 30 obtains a required resource amount for a user app for each state of vehicle 1 (specifically, required resource amount information indicating the required resource amount) (S110). For example, app control device 30 downloads the required resource amount information via a radio communication interface included in app control device 30.

App control device 30 then determines whether or not the required resource amount for each state of vehicle 1 is less than or equal to the remaining resource amount (S120). That is, app control device 30 determines, for each state of vehicle 1, whether or not the required resource amount is less than or equal to the remaining resource amount.

When the required resource amount for each state of vehicle 1 is less than or equal to the remaining resource amount (YES in S120), app control device 30 permits installation of the user app (S130). For example, when all the determination results for the different states of vehicle 1 show that the required resource amount is less than or equal to the remaining resource amount, app control device 30 determines that the determination result in step S120 is YES. In this case, app control device 30 causes a predetermined user app controller to install the user app. The predetermined user app controller can be arbitrarily determined and is not particularly limited.

On the other hand, when the required resource amount for each state of vehicle 1 is not less than or equal to the remaining resource amount (NO in S120), app control device 30 does not permit installation of the user app (S140). For example, when one or more of the determination results for the different states of vehicle 1 shows that the required resource amount is greater than the remaining resource amount, app control device 30 determines that the determination result in step S120 is NO. Note that in this case, information about the user app may be deleted or stored in the memory.

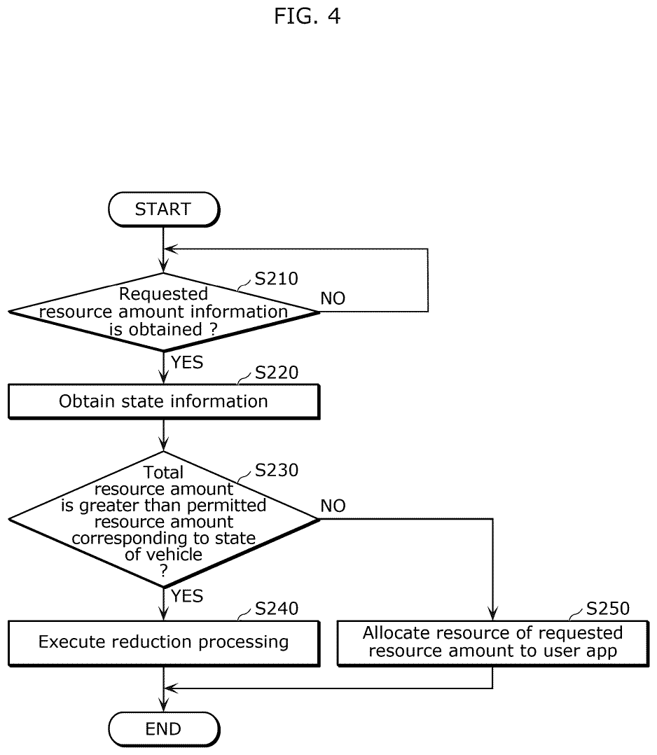

FIG. 4 is a flowchart illustrating app control processing by app control device 30 according to Embodiment 1. Note that it is assumed that the user app is being executed at the start of the flowchart of FIG. 4.

First, app control device 30 determines whether requested resource amount information indicating a requested resource amount requested by the user application being executed is obtained (S210). That is, app control device 30 determines whether a request for further resource is made by the user application being executed.

When it is determined that the requested resource amount information is not obtained (NO in S210), app control device 30 returns the processing to step S210.

On the other hand, when it is determined that the requested resource amount information is obtained (YES in S210), app control device 30 obtains state information indicating the state of vehicle 1 (S220).

App control device 30 then determines whether the total resource amount of the used resource amount allocated to the user app being executed in vehicle 1 and the requested resource amount indicated by the requested resource amount information is greater than the permitted resource amount for the state of vehicle 1 indicated by the state information specified for the user app (S230). For example, app control device 30 makes the determination in step S230 by obtaining used resource amount information indicating the used resource amount of the user app from each resource included in vehicle 1.

When the total resource amount is determined to be greater than the permitted resource amount (YES in S230), app control device 30 executes the reduction processing that reduces the resource amount allocated to the user app being executed to be less than the used resource amount (S240). In the reduction processing, for example, app control device 30 reduces the processing amount of the user app being executed. That is, app control device 30 reduces the processing amount of the user app controller.

On the other hand, when the total resource amount is determined not to be greater than the permitted resource amount, that is, the total resource amount is less than or equal to the permitted resource amount (NO in S230), app control device 30 allocates the requested resource amount of resource requested by the user app to the user app (S250). The user app controller continues executing the user app by using the total resource amount of resource.

### Effects and the Like

As described above, app control device 30 determines whether the total resource amount of the used resource amount allocated to the user app being executed in vehicle 1 and the requested resource amount requested by the user app being executed is greater than the permitted resource amount specified for the user app. And app control device 30 performs the reduction processing that reduces the resource amount allocated to the user app being executed to be less than the used resource amount when the total resource amount is determined to be greater than the permitted resource amount, and causes the user app to be executed using the total resource amount of resource when the total resource amount is determined to be less than or equal to the permitted resource amount.

Accordingly, the possibility of unexpected processing being executed by the user app can be reduced. Therefore, the safety of vehicle 1 in the case where the user app is used in vehicle 1 can be improved. Specifically, a failure of the user app and a security problem with the user app can be correctly and quickly detected, so that the safety of vehicle 1 using the user app is improved.

Furthermore, for example, in executing the reduction processing, app control device 30 executes the stop processing that stops processing of the user app being executed. That is, when accesses from a user app exceed the required resource amount specified for the user app in advance, app control device 30 stops processing of the user app.

Accordingly, the possibility of unexpected processing being executed by the user app can be further reduced. Therefore, the safety of vehicle 1 in the case where the user app is used in vehicle 1 can be further improved.

Furthermore, for example, app control device 30 obtains the state information indicating the state of vehicle 1, and in the determination of whether the total resource amount is greater than the permitted resource amount, app control device 30 uses, as the permitted resource amount, the resource amount corresponding to the state of vehicle 1 indicated by the state information among the plurality of resource amounts specified for different states of vehicle 1.

Accordingly, the determination is made according to the state of vehicle 1, so that whether the possibility of unexpected processing being executed by the user app can be correctly determined.

Furthermore, for example, the state information includes at least one of information indicating whether vehicle 1 is traveling or information indicating whether vehicle 1 is parked.

Accordingly, when the resource amount required for executing the user app varies depending on whether vehicle 1 is traveling and whether vehicle 1 is parked, in the determination of whether the total resource amount is greater than the permitted resource amount, whether the possibility of unexpected processing being executed by the user app can be correctly determined.

Furthermore, for example, the user app is an app different from an app preinstalled in vehicle 1.

Accordingly, the safety of vehicle 1 in the case where an app different from an app preinstalled in vehicle 1 is used in vehicle 1 can be improved.

Note that the present disclosure may be implemented as an app control method executed by app control device 30. For example, the app control method is an app control method executed by app control device 30 provided to vehicle 1, in which the total resource amount of the used resource amount allocated to the user app being executed in vehicle 1 and the requested resource amount requested by the user app being executed is greater than the permitted resource amount specified for the user app, and when the total resource amount is determined to be greater than the permitted resource amount, the reduction processing is executed which reduces the resource amount allocated to the user app being executed to be less than the used resource amount.

In this case, the same effects as those of app control device 30 are achieved.

Furthermore, the present disclosure may be implemented as a program for causing a computer to execute the app control method.

In this case, the same effects as those of app control device 30 are achieved.

### Summary

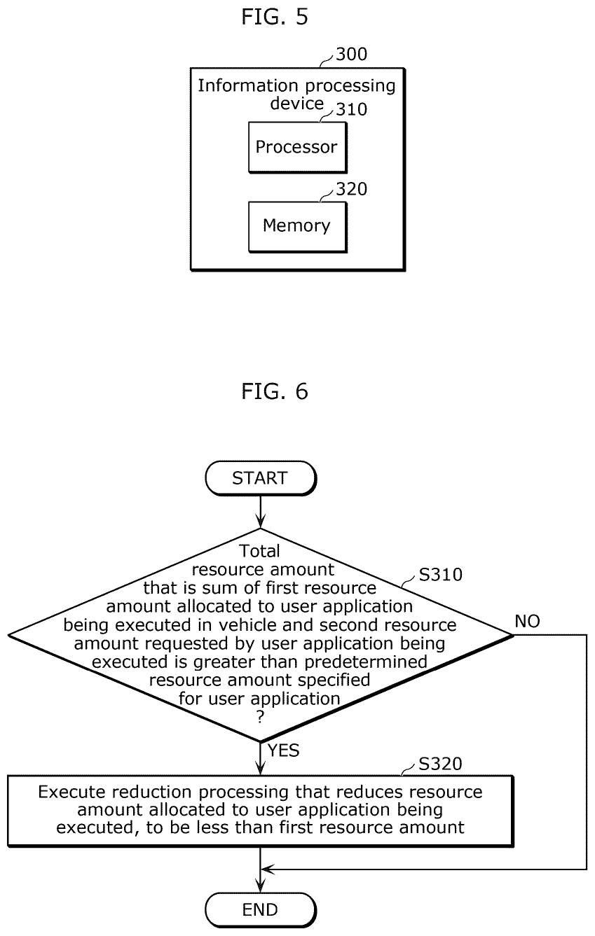

FIG. 5 is a block diagram illustrating a configuration of information processing device 300 according to Embodiment 1. FIG. 6 is a flowchart illustrating an information processing method according to Embodiment 1.

App control device 30 described above is a specific example of information processing device 300. Information processing device 300 includes processor 310 and memory 320, and processor 310 executes the information processing method illustrated in FIG. 6 by using memory 320. Memory 320 stores a control program to be executed by processor 310, for example. Processor 310 executes the control program stored in memory 320, for example. Information processing device 300 is provided to vehicle 1, for example.

First, information processing device 300 determines whether a total resource amount that is the sum of a first resource amount allocated to a user application being executed in vehicle 1 and a second resource amount requested by the user application being executed is greater than a predetermined resource amount specified for the user application (S310).

The first resource amount is the used resource amount described above, for example. The second resource amount is the requested resource amount described above, for example. The predetermined resource amount is the permitted resource amount described above, for example.

Information processing device 300 obtains first resource amount information indicating the first resource amount, for example. Furthermore, information processing device 300 obtains second resource amount information indicating the second resource amount, for example. Information processing device 300 calculates the total resource amount by summing the first resource amount and the second resource amount, for example. The first resource amount information can be obtained from any device, and for example, may be obtained from a user application (specifically, the user app controller executing the user application) or may be obtained from the ECU managing the resource used by the user application. The second resource amount is the requested resource amount information described above, for example. The second resource amount information is obtained from a user application (specifically, the user app controller executing the user application), for example.

When the total resource amount is determined to be greater than the predetermined resource amount (YES in S310), information processing device 300 executes reduction processing that reduces the resource amount allocated to the user application being executed to be less than the first resource amount (S320).

On the other hand, for example, when the total resource amount is determined to be less than or equal to the predetermined resource amount (NO in S310), information processing device 300 causes the user application to be executed using the total resource amount of resource. For example, information processing device 300 outputs, to the user app controller executing the user application, permission information indicating that using the requested resource amount of resource is permitted, thereby causing the user app controller to execute the user application by using the total resource amount of resource.

In step S320, for example, information processing device 300 executes stop processing that stops processing of the user application being executed. As the stop processing, for example, information processing device 300 outputs, to the user app controller executing the user application, instruction information indicating an instruction to stop processing of the user application being executed, thereby causing processing of the user application being executed to be stopped. Here, depending on the user application, processing of the user application being executed may be unable to be immediately stopped. In such a case, in step S320, information processing device 300 causes the processing of the user application to be executed by minimizing the processing of the user application being executed, that is, by reducing the resource amount allocated for execution of the user application. In this case, as the stop processing, for example, information processing device 300 outputs instruction information indicating an instruction to reduce the resource amount allocated to the user application being executed, thereby reducing the resource amount allocated to the user application being executed.

In this way, the possibility of unexpected processing being executed by the user application can be reduced. Therefore, the safety of vehicle 1 in the case where the user application is used in vehicle 1 can be improved.

Furthermore, for example, information processing device 300 obtains state information indicating the state of vehicle 1, and in the determination of whether the total resource amount is greater than the predetermined resource amount (S310), information processing device 300 uses the resource amount corresponding to the state of vehicle 1 indicated by the state information among a plurality of resource amounts specified in advance for different states of vehicle 1.

Accordingly, the determination is made according to the state of vehicle 1 in step S310, so that whether the possibility of unexpected processing being executed by the user application can be correctly determined.

Furthermore, for example, the state information includes at least one of information indicating whether vehicle 1 is traveling or information indicating whether vehicle 1 is parked.

Accordingly, when the resource amount required for executing the user application varies depending on whether vehicle 1 is traveling and whether vehicle 1 is parked, in the determination of whether the total resource amount is greater than the permitted resource amount, whether the possibility of unexpected processing being executed by the user application can be correctly determined.

Furthermore, for example, the user application is an application different from an application preinstalled in vehicle 1.

Accordingly, the safety of vehicle 1 in the case where an application different from applications preinstalled in vehicle 1 is used in vehicle 1 can be improved.

Note that these general or specific aspects may be implemented by a system, a method, an integrated circuit, a computer program, or a non-temporary recording medium readable by a computer, such as a CD-ROM, or may be implemented by an arbitrary combination of a system, a method, an integrated circuit, a computer program, and a recording medium. The program may be stored in advance in a recording medium or may be loaded to a recording medium via a wide area communication network, such as the Internet.

### Embodiment 2

### Underlying Knowledge Forming Basis of the Present Embodiment

It is expected that in the future, users will be able to arbitrarily introduce a user application to a vehicle to add, to the vehicle, a function executable by the vehicle. That is, it is expected that the authority to control devices (referred to also as resources) included in the vehicle, such as an ECU, a display, and lighting equipment, is granted to user applications. For example, the authority to control a vehicle resource is expected to be granted to user applications, provided that the function is not directly linked to the life of the passengers of the vehicle.

A user application is an application used by a user in a vehicle. The user application is introduced to (specifically, installed in) the vehicle by the user and used by the user in the vehicle. The user application is an application that controls a vehicle resource to be controlled by the basic application preinstalled in the vehicle instead of the basic application or in cooperation with the basic application.

When such a user application is used, the experience value of the user application for users has to be maximized while guaranteeing the operation of the basic application relating to the peace of mind of users, that is, the safety of users.

PTL 1 discloses a technique of stopping or restarting processing of an

extended application, using a threshold of a resource requested by the extended application specified for each state of a vehicle. However, when processing of the extended application is stopped or restarted, the experience value of the user application for the user is compromised, for example, an overhead of the activation processing for the extended application occurs, or indications by the user application on the display disappear. Therefore, to reduce the loss of the experience value for the user, the user application is desirably efficiently executed in the vehicle.

Thus, the inventor has devised the present embodiment.

In other words, among limited resources included in the vehicle, in particular, applications used by a user such as a driver in a vehicle (referred to also as user applications) are desirably efficiently executed.

The present embodiment provides an information processing device that can efficiently execute a user application in a vehicle.

### Configuration

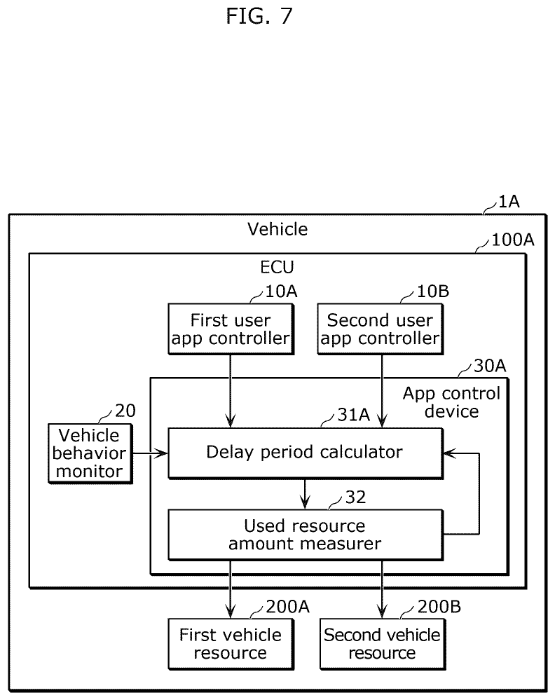

FIG. 7 is a block diagram illustrating a configuration of vehicle 1A according to Embodiment 2.

Vehicle 1A is a vehicle such as an automobile or a motorcycle. Vehicle 1A includes ECU 100A, first vehicle resource 200A, and second vehicle resource 200B. Note that the number of vehicle resources of vehicle 1A is not limited to 2 and can be any number equal to or greater than 1.

ECU 100A is an onboard ECU provided to vehicle 1A and executes control of the resources of vehicle 1A. ECU 100A is a device that includes a digital circuit such as a processor (microprocessor) and a memory, an analog circuit, and a communication circuit, for example. The memory is implemented as a ROM or a RAM, for example. The memory stores a control program (computer program) to be executed by the processor. For example, the processor operates according to the control program (computer program) to make ECU 100A implement various functions. The control program includes a user application (user app), for example. ECU 100A may include a storage device, such as a semiconductor memory or an HDD.

Note that the application (application program) is also referred to simply as app. For example, the user application is also referred to simply as user app, and the basic application is also referred to simply as basic app.

The user app is an app different from the basic app preinstalled in vehicle 1A, for example. The user app may be an app that is made executable by an operation by (or a contract to) a user or an app installed by a user, for example. The user app may be an app that can execute a function that is more advanced than functions that can be executed by the basic app, for example.

Examples of the user app include an entertainment app that uses only a resource for outputting sound, such as audio equipment, when vehicle 1A is traveling and uses not only audio equipment but also other resources, such as a display device and a room lamp, when vehicle 1A is stopped. Examples of the user app further include an autonomous parking app that uses only resources such as the driving mechanism such as the engine for controlling the traveling of vehicle 1A and a camera for taking images of the surroundings of vehicle 1A during autonomous parking of vehicle 1A and uses only recourses such as a microphone for recognizing the voice of the user that causes vehicle 1A to autonomously park at any time other than during autonomous parking of vehicle 1A. The user app may be an app that uses different amounts of resources depending on the state of vehicle 1A, for example.

Resource means a device that is included in vehicle 1A and can be used by a user app. Examples of the resource include a processor and a memory. Resource amount means the capacity of a CPU included in vehicle 1A, the capacity of a DRAM, the bandwidth of the DRAM, the capacity of a storage, the bandwidth of the storage, the transfer volume in a network, and the bandwidth in the network, for example.

Note that the resource may be onboard equipment included in vehicle 1A, such as lighting equipment, a display device, or an air conditioner. First vehicle resource 200A and second vehicle resource 200B are specific examples of the resources included in vehicle 1A.

Furthermore, a plurality of ECUs are provided to vehicle 1A. For example, the plurality of ECUs can communicate with each other over an onboard communication network (more specifically, buses to which the ECUs are connected). At least one of the plurality of ECUs has to have the configuration of ECU 100A illustrated in FIG. 7.

Furthermore, ECU 100A may be an ECU that is disposed in vehicle 1A and controls a resource in a region in which ECU 100A is disposed (the so-called zone ECU) or a central ECU that integrates a plurality of ECUs (the so-called integrated ECU). The integrated ECU is an ECU that integrates functions conventionally distributed among a plurality of ECUs in order to solve problems of the development time and cost increasing as the onboard system becomes complicated, to which the virtualization technology is applied for making one ECU operate as a plurality of virtual computers (virtual machines).

When the user app installed in vehicle 1A is executed, ECU 100A serves as control equipment that controls a device included in vehicle 1A. ECU 100A includes first user app controller 10A, second user app controller 10B, vehicle behavior monitor 20, and app control device 30A.

Note that the number of user apps of ECU 100A is not limited to 2 and can be any number equal to or greater than 1.

Furthermore, ECU 100A has a basic app (not shown). The basic app may be included in the control program described above. Furthermore, ECU 100A may further include a processing unit that executes the basic app.

Each of first user app controller 10A and second user app controller 10B is a processing unit that executes a user app. In the present embodiment, first user app controller 10A is a processing unit that executes a first user app, and second user app controller 10B is a processing unit that executes a second user app. The first user app and the second user app are examples of the user app installed in vehicle 1A by the user.

The user app is an app created by a party other than the manufacturer of the basic app. Each of first user app controller 10A and second user app controller 10B, for example, executes a user app to control a resource included in vehicle 1A. Specifically, each of first user app controller 10A and second user app controller 10B, for example, executes a user app to control onboard equipment using a resource included in vehicle 1A.

Each of first user app controller 10A and second user app controller 10B outputs, to app control device 30A, information that requests control of a resource included in vehicle 1A, and controls a vehicle device when permitted by app control device 30A. When executing the first user app, first user app controller 10A outputs, to app control device 30A, requested resource amount information that indicates the resource amount required for executing the user app (information that indicates the kind of the resource required for executing the user app and the resource amount, for example). When first user app controller 10A obtains, from app control device 30A as a response to the requested resource amount information, permission information that indicates execution of the first user app is permitted, first user app controller 10A executes the first user app using the resource amount of resource, thereby controlling the onboard equipment.

Note that first user app controller 10A and second user app controller 10B may be apps that use different resources or apps that use a common resource. For example, first user app controller 10A may control first onboard equipment using first vehicle resource 200A, and second user app controller 10B may control second onboard equipment different from the first onboard equipment using second vehicle resource 200B.

In the following, a process common to first user app controller 10A and second user app controller 10B may be described by using the term “user app controller”.

Vehicle behavior monitor 20 is a processing unit that has a function of monitoring the behavior of vehicle 1A and monitors the state of vehicle 1A including the behavior of vehicle 1A. For example, vehicle behavior monitor 20 monitors the state of vehicle 1A by obtaining sensing data from a plurality of sensors (not shown) provided to vehicle 1A.

The examples of the plurality of sensors include a velocity sensor, an acceleration sensor, a position sensor (a GPS sensor, for example), a steering angle sensor, a camera, an obstacle sensor, and/or an illuminance sensor.

Note that the plurality of sensors are not limited to these sensors, and any kind of sensors can be used as the plurality of sensors. Furthermore, the camera may be a camera that takes an image of the interior of vehicle 1A or a camera that takes an image of the outside of vehicle 1A. Furthermore, the obstacle sensor may be a sensor that detects an obstacle in the surroundings of vehicle 1A by LiDAR, for example. However, the obstacle sensor is not limited to this and can be any sensor that detects an obstacle in the surroundings of vehicle 1A in any manner. Furthermore, the illuminance sensor may measure the illuminance inside vehicle 1A or measure the illuminance outside vehicle 1A.

Vehicle behavior monitor 20, for example, obtains, from the plurality of sensors as state information indicating the state of vehicle 1A, information indicating at least one of the velocity of vehicle 1A, the position of vehicle 1A, the steering angle of vehicle 1A, the travel direction of vehicle 1A, or the surrounding environment of vehicle 1A. Vehicle behavior monitor 20 outputs the obtained state information to delay period calculator 31A.

Furthermore, based on the velocity of vehicle 1A indicated by the state information, vehicle behavior monitor 20 may determine whether vehicle 1A is traveling, whether vehicle 1A is traveling at low velocity, whether vehicle 1A is traveling at high velocity, and/or whether vehicle 1A is stopped. Furthermore, for example, vehicle behavior monitor 20 may obtain, as the state information, information indicating the result of these determinations. That is, vehicle behavior monitor 20 may obtain, as the state information, information indicating whether vehicle 1A is traveling. In other words, the state information includes information indicating whether vehicle 1A is traveling, for example.

Note that traveling at low velocity means a state where vehicle 1A is traveling at a velocity lower than a predetermined threshold. On the other hand, traveling at high velocity means a state where vehicle 1A is traveling at a velocity equal to or higher than the predetermined threshold. The predetermined threshold can be arbitrarily specified in advance and is not particularly limited. Information indicating the predetermined threshold is stored in advance in, for example, the memory included in ECU 100.

Furthermore, based on the position of vehicle 1A indicated by the state information, vehicle behavior monitor 20 may determine whether vehicle 1A is traveling at a predetermined location or in a predetermined area. Furthermore, for example, vehicle behavior monitor 20 may obtain, as the state information, information indicating the result of the determination. The predetermined location and the predetermined area can be arbitrarily specified in advance and are not particularly limited. A map and information indicating the predetermined location and the predetermined area are stored in advance in the memory included in ECU 100A.

Furthermore, based on the position of vehicle 1A indicated by the state information, vehicle behavior monitor 20 may determine whether vehicle 1A is passing through an intersection and/or whether vehicle 1A is crossing a crosswalk. Furthermore, for example, vehicle behavior monitor 20 may obtain, as the state information, information indicating the result of the determination.

Furthermore, based on the steering angle of vehicle 1A indicated by the state information, vehicle behavior monitor 20 may determine whether vehicle 1A is traveling on a curve (whether vehicle 1A is turning left or right or not, for example) and/or whether vehicle 1A is traveling straight. Furthermore, for example, vehicle behavior monitor 20 may obtain, as the state information, information indicating the result of the determination.

Furthermore, based on the travel direction of vehicle 1A indicated by the state information, vehicle behavior monitor 20 may determine whether vehicle 1A is traveling forward or backward. Furthermore, for example, vehicle behavior monitor 20 may obtain, as the state information, information indicating the result of the determination.

Furthermore, based on the illuminance value of the illuminance sensor indicated by the state information, vehicle behavior monitor 20 may determine whether the surroundings of vehicle 1A are dark. Furthermore, for example, vehicle behavior monitor 20 may obtain, as the state information, information indicating the result of the determination.

Furthermore, vehicle behavior monitor 20 may obtain information indicating whether vehicle 1A is parked. For example, vehicle behavior monitor 20 may determine whether vehicle 1A is parked (in a parking mode) based on the position of the shift lever indicated by the state information. Furthermore, for example, vehicle behavior monitor 20 may obtain, as the state information, information indicating the result of the determination. In other words, the state information includes information indicating whether vehicle 1A is parked, for example.

Note that the state information may include information indicating whether vehicle 1A is being parked by autonomous driving. Vehicle 1A may be capable of autonomous driving or may be remotely controlled. Vehicle behavior monitor 20 may obtain information indicating whether vehicle 1A is driving autonomously, for example.

Furthermore, vehicle behavior monitor 20 may obtain, as the state information, information indicating a current travel mode of vehicle 1A. Examples of the travel mode include an autonomous driving mode and a mode of traveling by following another vehicle under adaptive cruise control (ACC), for example.

The parking mode may be included in the travel mode. Vehicle behavior monitor 20 may obtain, as the state information, whether vehicle 1A is driving autonomously and/or whether vehicle 1A is operating under ACC. Furthermore, for example, vehicle behavior monitor 20 may obtain, as the state information, information indicating the result of these determinations.

As described above, the state information may include information indicating whether vehicle 1A is traveling, whether vehicle 1A is traveling at a predetermined location or in a predetermined area, whether vehicle 1A is passing through an intersection, and whether vehicle 1A is parked, for example.

App control device 30A is a processing unit that controls (manages) an app provided in vehicle 1A. App control device 30A controls installation of a user app to vehicle 1A or controls execution of a user app installed in vehicle 1A, for example. App control device 30A determines whether to permit the user app controller (first user app controller 10A and/or second user app controller 10B in the present embodiment) to install or execute a user app.

App control device 30A includes delay period calculator 31A and used resource amount measurer 32.

Delay period calculator 31A is a processing unit that determines whether a total resource amount that is a sum of a used resource amount allocated to a user app being executed in vehicle 1A and a requested resource amount requested by the user app being executed is greater than a permitted resource amount specified for the user app. For example, when the requested resource amount is increased, that is, an increased amount of resource is requested by the user app controller executing the user app, or in other words, requested resource amount information indicating the requested resource amount is obtained from the user app controller, delay period calculator 31A determines whether the total resource amount of the used resource amount used by the user app executed in vehicle 1 and the requested resource amount is less than or equal to the permitted resource amount specified for the user app.

Delay period calculator 31A obtains used resource amount information from used resource amount measurer 32, for example. Furthermore, delay period calculator 31A obtains requested resource amount information indicating the requested resource amount from the user app controller, for example. The used resource amount is an example of a first resource amount, and the used resource amount information is an example of first resource amount information. The requested resource amount is an example of a second resource amount, and the requested resource amount information is an example of second resource amount information.

For each of a plurality of user apps, a permitted resource amount is specified in advance. When delay period calculator 31A obtains requested resource amount information, for example, delay period calculator 31A determines whether the total resource amount is less than or equal to the permitted resource amount based on the permitted resource amount specified for the user app being executed by the user app controller that has output the requested resource amount information.

Information indicating the permitted resource amount specified for each of the plurality of user apps is stored in advance in the memory included in app control device 30A, for example. The permitted resource amounts specified for the plurality of user apps may be the same or different, and are not particularly limited. The permitted resource amount is an example of a predetermined resource amount.

When the total resource amount is determined to be less than or equal to the permitted resource amount, for example, delay period calculator 31A causes processing of the user application (requested app processing) to be executed. When the total resource amount is determined to be less than or equal to the permitted resource amount, for example, delay period calculator 31A allocates the requested resource amount of resource to the user app. This allows the user app controller to continue executing the user app by using the total resource amount of resource.

On the other hand, when the total resource amount is determined to be greater than the permitted resource amount, delay period calculator 31A executes delay processing that causes the requested app processing to be executed with a delay. That is, when the total resource amount is determined to be less than or equal to the permitted resource amount, delay period calculator 31A executes delay processing that causes the user app to execute requested app processing in such a manner that the requested app processing takes a longer time than when the requested resource amount of resource is immediately allocated and the user app executes the requested app processing. The requested app processing is an example of the first processing. The delay processing is an example of second processing.

In the delay processing, delay period calculator 31A executes processing that delays the timing of starting the requested app processing, for example. Alternatively, if there is an available resource in vehicle 1A and there is a process that can be executed earlier than the other processes in the requested app processing, in the delay processing, delay period calculator 31A causes a part of the requested app processing to be executed earlier. That is, in the delay processing, for example, delay period calculator 31A allocates a smaller resource amount of resource than the requested resource amount to the user app. In the delay processing, for example, delay period calculator 31A allocates the resource to the user app in such a manner that the sum of the used resource amount of the user app and the allocated resource amount is less than or equal to the permitted resource amount allocated for the user app.

In the delay processing, for example, delay period calculator 31A calculates a predetermined period based on the total resource amount, and causes the user app to execute the requested app processing based on the calculated predetermined period. For example, delay period calculator 31A causes the user app to execute the requested app processing after a calculated delay period elapses from when the requested resource amount is requested by the user app. The delay period is an example of the predetermined period.

For example, delay period calculator 31A calculates the delay period in such a manner that the resource amount per unit time used by the user app does not exceed the permitted resource amount per unit time specified for the user app. For example, delay period calculator 31A calculates the delay period based on the used resource amount per unit time, the requested resource amount, and the permitted resource amount per unit time.

For example, delay period calculator 31A calculates X=(used resource amount per unit time)+(requested resource amount)−(permitted resource amount per unit time). For example, when X>0, delay period calculator 31A calculates (unit time×X)/(permitted resource amount per unit time) as the delay period. For example, when X≤0, delay period calculator 31A sets the delay period to be 0. That is, in this case, delay period calculator 31A immediately allocates the requested resource amount of resource to the user app and immediately causes the user app to execute the requested app processing.

Note that the delay period can be arbitrarily specified in advance and is not particularly limited. Information indicating the delay period may be stored in advance in the memory included in app control device 30A.

Furthermore, the unit time can be arbitrarily specified in advance and is not particularly limited. Information indicating the unit time may be stored in advance in the memory included in app control device 30A.

Furthermore, when the total resource amount is determined to be greater than the permitted resource amount, delay period calculator 31A may reduce the priority of the access to the resource by the user app controller having transmitted the requested resource amount information. Priorities are specified in advance for a plurality of apps included in vehicle 1A, for example. When delay period calculator 31A obtains requested resource amount information from a plurality of app controllers executing a plurality of apps, delay period calculator 31A determines whether to permit execution of each of the plurality of apps based on the priorities specified for the plurality of apps. That is, when resource requests from a plurality of user apps occur, delay period calculator 31A determines whether to approve the resource request from each of the plurality of apps, that is, whether to permit access to the resource by each of the plurality of apps, based on the priority specified for the app. For example, when a plurality of apps request to access the same resource, delay period calculator 31A permits only the app having the highest priority to access the resource.

Furthermore, the priority of each of the plurality of apps can be arbitrarily specified in advance and is not particularly limited. Information indicating the priorities of the plurality of apps is stored in advance in the memory included in app control device 30A, for example. Furthermore, the extent of the reduction of the priority of the user app can be arbitrarily determined and is not particularly limited. For example, when the total resource amount is determined to be greater than the permitted resource amount, delay period calculator 31A may reduce the priority of the user app to be the lowest among the plurality of user apps included in vehicle 1A.

Furthermore, app control device 30A may include a timer for measuring time, such as a real time clock (RTC).

In the delay processing, for example, delay period calculator 31A determines whether a predetermined vehicle resource (first vehicle resource 200A and/or second vehicle resource 200B, for example) included in vehicle 1A is allocated for execution of another application until the delay period elapses from when the requested resource amount is requested by the user app. For example, delay period calculator 31A determines whether there is a request to use a predetermined vehicle resource from another user app, and delay period calculator 31A determines that the predetermined vehicle resource is allocated for execution of the other app when there is the request, and determines that the predetermined vehicle resource is not allocated for execution of another app when there is not the request. When the predetermined vehicle resource is determined to be allocated for execution of another app, for example, delay period calculator 31A does not cause processing of the user app using the predetermined vehicle resource (additional processing) to be executed until the delay period elapses from when the requested resource amount is requested by the user app. That is, in this case, delay period calculator 31A does not approve the request from the user app. On the other hand, when the predetermined vehicle resource is determined not to be allocated for execution of another app, delay period calculator 31A causes the processing of the user app using the predetermined vehicle resource to be executed. That is, in this case, delay period calculator 31A permits the user app to use the predetermined vehicle resource in response to the request from the user app.

As described above, when the total resource amount is determined to be greater than the permitted resource amount, for example, delay period calculator 31A reduces the priority of the user app having requested the resource to be lower than the priorities of the other apps included in vehicle 1A, and when there is a resource that is not used by any app, delay period calculator 31A permits the user app to use the resource only when the resource is not used by the other apps. On the other hand, for example, even when there is a resource that is not used by any app, if there is a request for a resource from another app, delay period calculator 31A allocates the resource to the other app, rather than the user app.

Furthermore, for each of the plurality of user apps, a permitted resource amount that depends on the state of vehicle 1A may be specified in advance. For example, for each of the plurality of user apps, a permitted resource amount in the case where the state of vehicle 1A is traveling and a permitted resource amount in the case where the state of vehicle 1A is stopped are specified. Furthermore, for example, for each of the plurality of user apps, a permitted resource amount in the case where the state of vehicle 1A is parked and a permitted resource amount in the case where the state of vehicle 1A is not parked are specified. For example, delay period calculator 31A obtains state information indicating the state of vehicle 1A, and in determining whether the total resource amount is greater than the permitted resource amount, delay period calculator 31A uses, as the permitted resource amount, the resource amount corresponding to the state of vehicle 1A indicated by the state information among a plurality of resource amounts specified in advance according to the state of vehicle 1A. That is, delay period calculator 31A determines whether the total resource amount is less than or equal to the permitted resource amount corresponding to the state of vehicle 1A. The state information is obtained from vehicle behavior monitor 20, for example.

When all the determination results for different states of vehicle 1A show that the total resource amount is less than or equal to the permitted resource amount, delay period calculator 31A permits execution of the user app using the requested resource amount. Otherwise, delay period calculator 31A executes the second processing (delay processing).

Used resource amount measurer 32 is a processing unit that obtains used resource amount information. Used resource amount measurer 32 obtains used resource amount information indicating the used resource amount by measuring the used amount of each resource included in vehicle 1A by the user app. Specifically, used resource amount measurer 32 obtains the used resource amount information indicating the used resource amount by obtaining information indicating the user app being executed from each resource (first vehicle resource 200A and second vehicle resource 200B in the present embodiment) included in vehicle 1A.

Note that the used resource amount may be a resource amount used per unit time or an accumulated value of the used resource amount.

Furthermore, delay period calculator 31A determines whether to permit installation of a user app, for example. For example, when delay period calculator 31A obtains required resource amount information indicating a user app and a resource amount (required resource amount) required for executing the user app via a radio communication interface included in app control device 30A, delay period calculator 31A determines whether or not the required resource amount is less than or equal to the resource amount (remaining resource amount) that is available in vehicle 1A. When the required resource amount is determined to be less than or equal to the remaining resource amount, delay period calculator 31A permits installation of the user app. For example, delay period calculator 31A causes the user app controller to execute installation of the user app. On the other hand, when the required resource amount is determined to be greater than the remaining resource amount, for example, delay period calculator 31A does not permit installation of the user app and prevents installation of the user app.

Delay period calculator 31A calculates the remaining resource amount based on an overall resource amount (overall resource amount) in vehicle 1A and the used resource amount being used in vehicle 1A, for example.

Overall resource amount information indicating the overall resource amount is stored in advance in the memory included in app control device 30A, for example.

Note that the required resource amount information may include information indicating a required resource amount corresponding to the state of vehicle 1A. For example, the required resource amount information may include information indicating a resource amount in the case where vehicle 1A is traveling and information indicating a resource amount in the case where vehicle 1A is stopped. Furthermore, the overall resource amount information may include information indicating a resource amount corresponding to the state of vehicle 1A. For example, delay period calculator 31A may determine whether or not the required resource amount is less than or equal to the remaining resource amount for each state of vehicle 1A. For example, when all the determination results for different states of vehicle 1A show that the required resource amount is less than or equal to the remaining resource amount, delay period calculator 31A permits installation of the user app. Otherwise, delay period calculator 31A does not permit installation of the user app.

Next, resource amounts according to the present embodiment will be described with reference to FIG. 2. In the present embodiment, part (a) of FIG. 2 is a diagram schematically illustrating the overall resource amount of vehicle 1A, part (b) of FIG. 2 is a diagram schematically illustrating the permitted resource amount for each app, and part (c) of FIG. 2 is a diagram schematically illustrating the total resource amount for each app.

The remaining resource amount is the difference between the overall resource amount and the used resource amount, for example. The permitted resource amount is the same resource amount as the required resource amount indicated by the required resource amount information obtained along with the user app when the user app is installed, for example.

In the example illustrated in FIG. 2, for example, the permitted resource amount for a first user app is A1, and the total resource amount for the first user app is A2. In this case, delay period calculator 31A executes the second processing for the first user app, since A1<A2. For example, delay period calculator 31A causes the processing of the first user app to be executed with a delay after a predetermined period elapses.

Furthermore, in the example illustrated in FIG. 2, the permitted resource amount for a second user app is A3, and the total resource amount for the second user app is A4, for example. In this case, delay period calculator 31A permits the second user app to use the requested resource.

Each of the processing units included in ECU 100A, such as first user app controller 10A, second user app controller 10B, vehicle behavior monitor 20, delay period calculator 31A, and used resource amount measurer 32, is implemented by a processor and a memory that stores a control program to be executed by the processor. Furthermore, each processing unit may include a radio communication interface including a radio communication circuit and an antenna for obtaining (downloading) a user app.

First vehicle resource 200A and second vehicle resource 200B are resources communicatively connected to ECU 100A by an onboard communication network. First vehicle resource 200A and second vehicle resource 200B are physical devices provided to vehicle 1A, for example. First vehicle resource 200A and second vehicle resource 200b are implemented by a processor and/or a memory, for example.

First vehicle resource 200A and second vehicle resource 200B are used for executing a user app, for example, and control onboard equipment, such as lighting equipment including a headlight, a display device, a digital mirror, a room lamp, a power window, an air conditioner, a lock, and/or audio equipment.

Note that first vehicle resource 200A and second vehicle resource 200B may control common onboard equipment or different onboard equipment.

Furthermore, first vehicle resource 200A and second vehicle resource 200B may be used for executing a user app or may be used for executing the basic app. Furthermore, first vehicle resource 200A and second vehicle resource 200B may be used for other processing than processing of an app executed in vehicle 1A.

Furthermore, first vehicle resource 200A and second vehicle resource 200B may be the onboard equipment described above.

### Processing Procedure

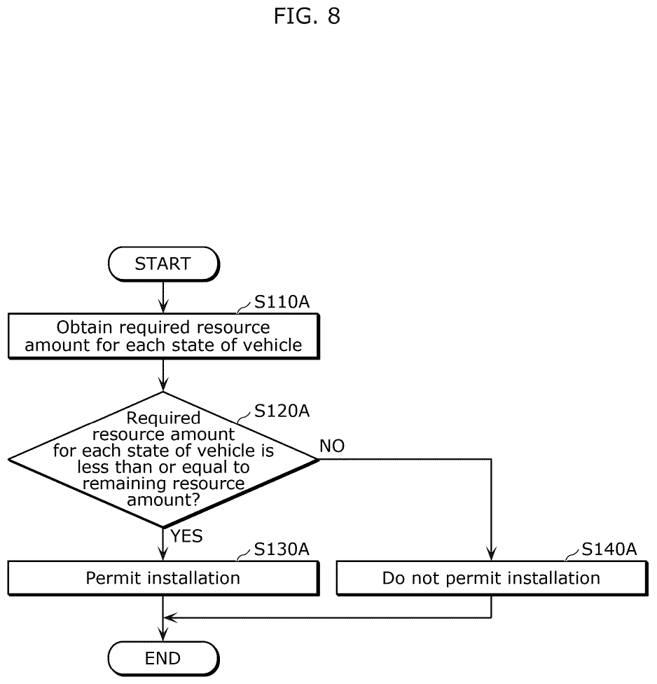

FIG. 8 is a flowchart illustrating installation processing by app control device 30A according to Embodiment 2.

First, app control device 30A obtains a required resource amount for a user app for each state of vehicle 1A (specifically, required resource amount information indicating the resource amount) (S110A). For example, app control device 30A downloads the required resource amount information via a radio communication interface included in app control device 30A.

App control device 30A then determines whether or not the required resource amount for each state of vehicle 1A is less than or equal to the remaining resource amount (S120A). That is, app control device 30 determines, for each state of vehicle 1A, whether or not the required resource amount is less than or equal to the remaining resource amount.

When the required resource amount for each state of vehicle 1A is less than or equal to the remaining resource amount (YES in S120A), app control device 30A permits installation of the user app (S130A). For example, when all the determination results for the different states of vehicle 1A show that the required resource amount is less than or equal to the remaining resource amount, app control device 30A determines that the determination result in step S120A is YES. In this case, app control device 30A causes a predetermined user app controller to install the user app. The predetermined user app controller can be arbitrarily determined and is not particularly limited.

On the other hand, when the required resource amount for each state of vehicle 1A is not less than or equal to the remaining resource amount (NO in S120A), app control device 30A does not permit installation of the user app (S140A). For example, when one or more of the determination results for the different states of vehicle 1A shows that the required resource amount is greater than the remaining resource amount, app control device 30A determines that the determination result in step S120A is NO. Note that in this case, information about the user app may be deleted or stored in the memory.

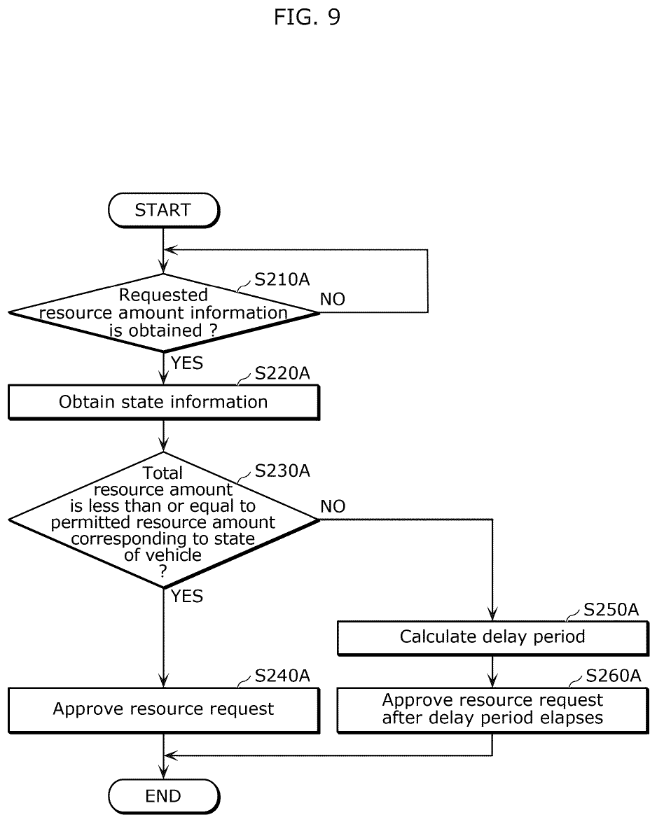

FIG. 9 is a flowchart illustrating app control processing by app control device 30A according to Embodiment 2. Note that it is assumed that the user app is being executed at the start of the flowchart of FIG. 9.

First, app control device 30A determines whether requested resource amount information indicating a requested resource amount requested by the user application being executed is obtained (S210A). That is, app control device 30A determines whether a request for further resource is made by the user application being executed.

When it is determined that the requested resource amount information is not obtained (NO in S210A), app control device 30A returns the processing to step S210A.

On the other hand, when it is determined that the requested resource amount information is obtained (YES in S210A), app control device 30A obtains state information indicating the state of vehicle 1A (S220A).

App control device 30A then determines whether the total resource amount of the used resource amount allocated to the user app being executed in vehicle 1A and the requested resource amount indicated by the requested resource amount information is less than or equal to the permitted resource amount for the state of vehicle 1A indicated by the state information specified for the user app (S230A). For example, app control device 30A makes the determination in step S230A by obtaining used resource amount information indicating the used resource amount of the user app from each resource included in vehicle 1A.

When the total resource amount is determined to be less than or equal to the permitted resource amount (YES in S230A), app control device 30A approves the request for a resource from the user app (S240A). For example, app control device 30A allocates the resource amount of resource to the user app and causes the user app to continue executing using the total resource amount of resource.

On the other hand, when the total resource amount is determined to be greater than the permitted resource amount (NO in S230A), app control device 30A calculates the delay period that is a period until the request for a resource from the user app is approved (S250A).

App control device 30A then approves the request for a resource from the user app after the calculated delay period elapses (S260A).

### Effects and the Like

As described above, when a request for a resource from a user app exceeds a threshold (resource amount) specified for each state of vehicle 1A, for example, app control device 30A delays acceptance of the request for the resource so that the resource amount falls within the threshold. For example, delay period calculator 31A calculates (determines) the delay period based on the state of vehicle 1A, the permitted resource amount corresponding to the state of vehicle 1A, the total resource amount, and the past used resource amount of the user app per unit time, and delays acceptance of the request for the resource by the delay period. For example, when the requested resource amount (specifically, the total resource amount) is determined to exceed the threshold, app control device 30A determines the delay period in such a manner that the used resource amount per unit time does not exceed the threshold, accepts the request for the resource after delaying the acceptance of the request by the determined delay period, and then causes actual resource access (usage of the resource by the user app) to be started. On the other hand, when the requested resource amount does not exceed the threshold, app control device 30A immediately causes actual resource access to be started.

Conventionally, when a request for a resource from a user app is not approved (accepted), an error (error information) indicating that the resource cannot be used is output to the user app. When the user app obtains such an error, the user app makes a request for the resource again, for example. In this way, conventionally, when a request for a resource from a user app is not approved, the user app takes some action.

With app control device 30A, such a request for a resource is approved after a delay, so that such an error does not need to be output. Therefore, processing of the user app can be simplified.

Furthermore, compared with the case where the processing of making a request for a resource is executed again when the user app obtains an error, the period until a request for a resource is approved from when the first request for the resource is made can be reduced when the request is approved after a delay.

Note that app control device 30A may set the threshold to be lower in the case where vehicle 1A is traveling than in the case where vehicle 1A is stopped.

Furthermore, app control device 30A may set the threshold each time a resource is requested.

Furthermore, app control device 30A may sum the resource amounts requested by a plurality of user apps included in vehicle 1A and determine the threshold based on the sum of the resource amounts.

Furthermore, the resource included in vehicle 1A may be a CPU, a network, a DRAM, or a storage.

Furthermore, resource amount may mean the used amount of the resource or the bandwidth used by the resource.

Furthermore, when delaying processing of a user app, app control device 30A may reduce the priority of the user app using the resource, in addition to delaying acceptance of the request for the resource from the user app.

### Summary

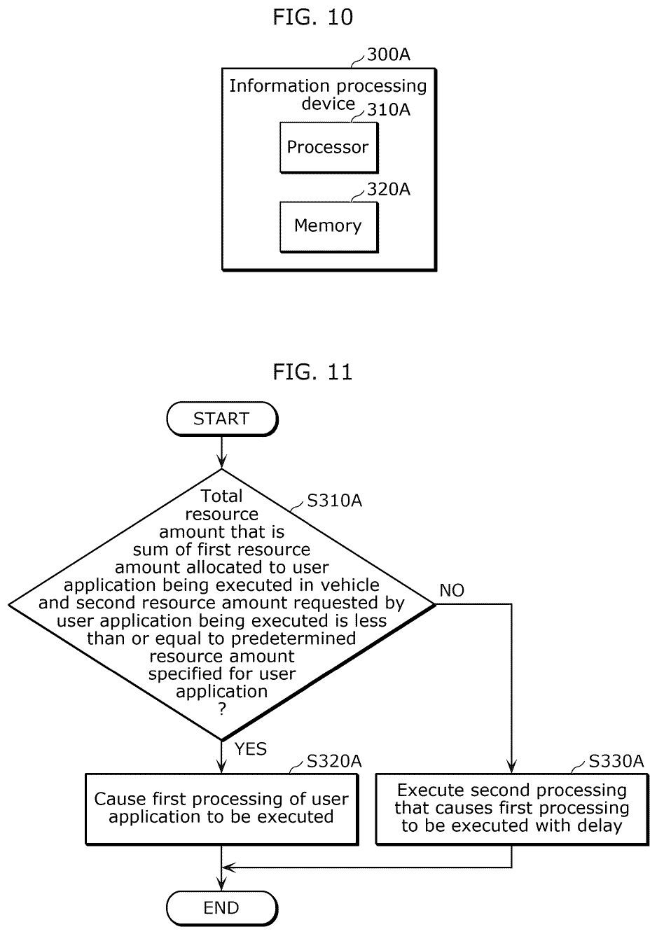

FIG. 10 is a block diagram illustrating a configuration of information processing device 300A according to Embodiment 2. FIG. 11 is a flowchart illustrating an information processing method according to Embodiment 2.

App control device 30A described above is a specific example of information processing device 300A. Information processing device 300A includes processor 310A and memory 320A, and processor 310A executes the information processing method illustrated in FIG. 11 by using memory 320A. Memory 320A stores a control program to be executed by processor 310A, for example. Processor 310A executes the control program stored in memory 320A, for example. Information processing device 300A is provided to vehicle 1A, for example.

First, information processing device 300A determines whether a total resource amount that is the sum of a first resource amount allocated to a user application being executed in vehicle 1A and a second resource amount requested by the user application being executed is less than or equal to a predetermined resource amount specified for the user application (S310A).

The first resource amount is the used resource amount described above, for example. The second resource amount is the requested resource amount described above, for example. The predetermined resource amount is the permitted resource amount described above, for example.

Information processing device 300A obtains first resource amount information indicating the first resource amount, for example. Furthermore, information processing device 300A obtains second resource amount information indicating the second resource amount, for example. Information processing device 300A calculates the total resource amount by summing the first resource amount and the second resource amount, for example. The first resource amount information can be obtained from any device, and for example, may be obtained from a user application (specifically, the user app controller executing the user application) or may be obtained from the ECU managing the resource used by the user application. The second resource amount is the requested resource amount information described above, for example. The second resource amount information is obtained from a user application (specifically, the user app controller executing the user application), for example.

When the total resource amount is determined to be less than or equal to the predetermined resource amount (YES in S310A), information processing device 300A causes first processing of the user application (S320A). That is, information processing device 300A causes the user application to be executed using the total resource amount of resource. For example, information processing device 300A outputs, to the user app controller executing the user application, permission information indicating that using the requested resource amount of resource is permitted, thereby causing the user app controller to execute the user application using the total resource amount of resource.

On the other hand, when the total resource amount is determined to be greater than the predetermined resource amount (NO in S310A), information processing device 300A executes second processing that causes the first processing to be executed with a delay (S330A). The first processing is the requested app processing described above, for example. The second processing is the delay processing described above, for example.

In step S330A, for example, information processing device 330A executes the same processing as step S320A after a predetermined period elapses from when the second resource amount information is obtained. Information processing device 300A calculates the predetermined period as the second processing, and executes the same processing as step S320A after the calculated predetermined period elapses. For example, information processing device 300A calculates the predetermined period based on the first resource amount per unit time, the second resource amount, and the predetermined resource amount per unit time.

Accordingly, the first processing is executed without the user application repeatedly outputting the second resource amount information, so that the processing amount of the user application can be reduced. Furthermore, compared with the case where the user application repeatedly outputs the second resource amount information, and the first processing is executed when such information is obtained, the timing of completion of the first processing executed when the total resource amount is determined to be greater than the predetermined resource amount can be advanced. Therefore, the user application can be efficiently executed in vehicle 1A.

Furthermore, for example, in step S330A, information processing device 300A determines whether a predetermined vehicle resource included in vehicle 1A is allocated for execution of another application until the predetermined period elapses from when the second resource amount is requested by the user application, and executes processing based on the result of the determination. When the predetermined vehicle resource is determined to be allocated for execution of the other app, for example, information processing device 300A does not cause the first processing to be executed until the predetermined period elapses from when the second resource amount is requested by the user application. Furthermore, for example, when the predetermined vehicle resource is determined not to be allocated for execution of the other application, information processing device 300A causes the first processing using the predetermined vehicle resource to be executed. That is, in this case, in other words, when there is an available resource in vehicle 1A, the first processing is executed using the resource.

Accordingly, the resource included in vehicle 1A can be efficiently used so that the resource does not become unnecessarily idle.

Note that the predetermined vehicle resource can be arbitrarily specified as far as it is a resource included in vehicle 1A, and is not particularly limited. Furthermore, the other application can be any application in vehicle 1A and is not particularly limited. The other application may be the basic application or another user application.

Furthermore, for example, information processing device 300A obtains state information indicating the state of vehicle 1A, and in the determination of whether or not the total resource amount is less than or equal to the predetermined resource amount (S310A), information processing device 300A uses the resource amount corresponding to the state of vehicle 1A indicated by the state information among a plurality of resource amounts specified in advance for different states of vehicle 1A.

Accordingly, the user application can be efficiently executed according to the state of the vehicle.

Furthermore, for example, the state information includes information indicating whether vehicle 1A is traveling.

Accordingly, when the resource amount required for execution of the user application varies depending on whether vehicle 1A is traveling, the user application can be efficiently executed according to the state of vehicle 1A.

Furthermore, for example, the user application is an application different from an application preinstalled in vehicle 1A.

Accordingly, when an application different from the applications preinstalled in vehicle 1A is used in vehicle 1A, the user application can be efficiently executed.

Note that these general or specific aspects may be implemented by a system, a method, an integrated circuit, a computer program, or a non-temporary recording medium readable by a computer, such as a CD-ROM, or may be implemented by an arbitrary combination of a system, a method, an integrated circuit, a computer program, and a recording medium. The program may be stored in advance in a recording medium or may be loaded to a recording medium via a wide area communication network, such as the Internet.

### Embodiment 3

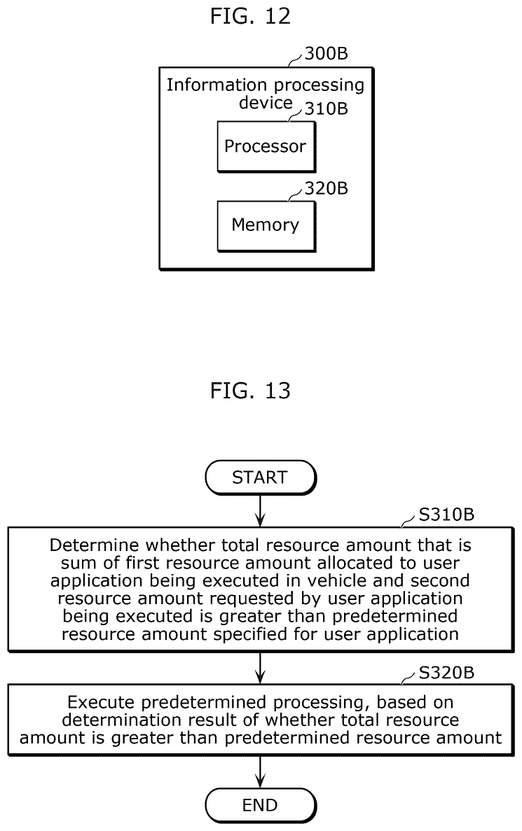

FIG. 12 is a block diagram illustrating a configuration of information processing device 300B according to Embodiment 3. FIG. 13 is a flowchart illustrating an information processing method according to Embodiment 3.

App control device 30 and app control device 30A described above are specific examples of information processing device 300B. For example, information processing device 300B is a device implemented by an arbitrary combination of components included in app control device 30 and app control device 30A. Furthermore, information processing device 300B executes an arbitrary combination of processing executed by app control device 30 and app control device 30A.

Information processing device 300B includes processor 310B and memory 320B, and processor 310B executes the information processing method illustrated in FIG. 13 by using memory 320B. Memory 320B stores a control program to be executed by processor 310B, for example. Processor 310B executes the control program stored in memory 320B, for example. Information processing device 300B is provided to a vehicle, for example.

First, information processing device 300B determines whether a total resource amount that is the sum of a first resource amount allocated to a user application being executed in the vehicle and a second resource amount requested by the user application being executed is greater than a predetermined resource amount specified for the user application (S310B).

The first resource amount is the used resource amount described above, for example. The second resource amount is the requested resource amount described above, for example. The predetermined resource amount is the permitted resource amount described above, for example.

Information processing device 300B obtains first resource amount information indicating the first resource amount, for example. Furthermore, information processing device 300B obtains second resource amount information indicating the second resource amount, for example. Information processing device 300B calculates the total resource amount by summing the first resource amount and the second resource amount, for example. The first resource amount information can be obtained from any device, and for example, may be obtained from a user application (specifically, the user app controller executing the user application) or may be obtained from the ECU managing the resource used by the user application. The second resource amount is the requested resource amount information described above, for example. The second resource amount information is obtained from a user application (specifically, the user app controller executing the user application), for example.

Information processing device 300B then executes predetermined processing based on the result of the determination of whether the total resource amount is greater than the predetermined resource amount (S320B).

The predetermined processing is the reduction processing described above, the stop processing described above, execution of a user application using the total resource amount of resource, the first processing described above, and/or the second processing (delay processing) described above, for example.

Accordingly, the possibility of unexpected processing being executed by the user application can be reduced, and the resource included in the vehicle can be efficiently used so that the resource does not become unnecessarily idle. Therefore, the execution of the application in the vehicle can be further improved.

### Other Embodiments

Hereinbefore, information processing devices according to one or more aspects have been described based on the exemplary embodiments, but the present disclosure is not limited to such exemplary embodiments. Various modifications of the exemplary embodiments as well as forms resulting from combinations of constituent elements in different embodiments that may be conceived by those skilled in the art may be included in the present disclosure so long as such modifications and forms do not depart from the essence of the present disclosure.

For example, although an example in which the vehicle includes one ECU is described in each embodiment described above, the vehicle may include a plurality of ECUs. For example, a first user app controller included in a first ECU may control a vehicle device that is to be controlled by a second ECU different from the first ECU via the app control device. For example, a user app may be able to control a vehicle device that is to be controlled by the second ECU different from the first ECU installed.

Furthermore, for example, in development of a user app, required resource amounts for different states of a vehicle for the user app may be specified. Furthermore, the app control device may permit installation of a user app only when there is room in the resource amounts specified for different states of the vehicle. Specifically, the app control device may compare the required resource amount specified for each state of the vehicle with the overall remaining resource amount of the vehicle, and permit installation of a user app only when there is room in the resource amounts of the vehicle.

For example, each of the constituent elements in the embodiments described above may be configured in the form of an exclusive hardware product, or may be implemented by executing a software program suitable for the constituent element. Each of the constituent elements may be implemented by means of a program executor, such as a CPU and a processor, reading and executing the software program recorded on a recording medium such as a hard disk or a semiconductor memory.

Also, the processing order of executing the steps shown in the flowcharts is a mere illustration for specifically describing the present disclosure, and thus may be an order other than the shown order. Also, one or more of the steps may be executed simultaneously (in parallel) with another step, and one or more of the steps may not be executed.

Moreover, the block diagrams illustrate one example of the division of functional blocks. A plurality of functional blocks may be implemented as a single functional block, a single functional block may be broken up into a plurality of functional blocks, and part of one function may be transferred to another functional block. In addition, functions of a plurality of functional blocks having similar functions may be processed in parallel or by time-division by a single hardware or software product.

The app control device according to the embodiments described above may be implemented as a single device or may be implemented by a plurality of devices. In the case of implementing the app control device using a plurality of devices, the constituent elements of the app control device may be allocated to the plurality of devices in any manner. In the case of implementing the app control device using a plurality of devices, the method of communication between the plurality of devices is not particularly limited and may be wireless communication or may be wired communication. The devices may communicate with each other using a combination of wireless communication and wired communication.

Furthermore, each of the constituent elements described in the exemplary embodiments may be implemented as a software product or may be typically implemented as a large-scale integrated (LSI) circuit, which is an integrated circuit (IC). These may take the form of individual chips, or may be partially or entirely packaged into a single chip. Although the term “LSI circuit” is used here, other names, such as IC, system LSI circuit, super LSI circuit, and ultra LSI circuit may be used, depending on the level of integration. The method for circuit integration is not limited to LSI, and it is also possible to use a dedicated circuit (a general-purpose circuit that executes a dedicated program) or a general-purpose processor. A field programmable gate array (FPGA) that is programmable after manufacturing of the LSI circuit, or a reconfigurable processor in which the connections and settings of the circuit cells within the LSI circuit are reconfigurable, may be used. Furthermore, when advancement in semiconductor technology or derivatives of other technologies brings forth a circuit integration technology which replaces LSI, it will be appreciated that such a circuit integration technology may be used to integrate the constituent elements.

A system LSI circuit is a super multifunctional LSI circuit manufactured by integrating a plurality of processing units on a single chip, and is specifically a computer system including, for example, a microprocessor, ROM, and RAM. A computer program is stored in the ROM. The system LSI circuit fulfills the functions as a result of the microprocessor operating according to the computer program.

Furthermore, an aspect of the present disclosure may be a computer program that causes a computer to execute each characteristic step included in the information processing method described above.

In addition, for example, the program may be a program to be executed by a computer. Furthermore, an aspect of the present disclosure may be a non-transitory computer-readable recording medium having such a program recorded thereon. For example, such a program may be recorded on a recording medium and distributed. For example, by installing the distributed program in a device that includes another processor and causing the processor to execute the program, it is possible to cause the device to perform each of the processes described above.

While various embodiments have been described herein above, it is to be appreciated that various changes in form and detail may be made without departing from the spirit and scope of the present disclosure as presently or hereafter claimed.

### Further Information About Technical Background to This Application

The disclosures of the following patent applications including specification, drawings, and claims are incorporated herein by reference in their entirety: Japanese Patent Application No. 2025-033946 filed on Mar. 4, 2025, and Japanese Patent Application No. 2025-033959 filed on Mar. 4, 2025.

### Industrial Applicability

The present disclosure is useful for, for example, a device that is to be provided to a vehicle and executes applications.

1. An information processing device to be provided to a vehicle, the information processing device comprising:
a processor; and
a memory, wherein
using the memory, the processor:
determines whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and
executes predetermined processing, based on a determination result of whether the total resource amount is greater than the predetermined resource amount.

2. The information processing device according to claim 1, wherein
when the total resource amount is determined to be greater than the predetermined resource amount, the processor executes reduction processing that reduces a resource amount allocated to the user application being executed, to be less than the first resource amount.

3. The information processing device according to claim 2, wherein
in executing the reduction processing, the processor executes stop processing that stops processing of the user application being executed.

4. The information processing device according to claim 1, wherein
when the total resource amount is determined to be less than or equal to the predetermined resource amount, the processor causes first processing to be executed by the user application, and
when the total resource amount is determined to be greater than the predetermined resource amount, the processor executes second processing that causes the first processing to be executed with a delay.

5. The information processing device according to claim 4, wherein
in the second processing, the processor:
calculates a predetermined period, based on the total resource amount; and
causes the first processing to be executed based on the predetermined period.

6. The information processing device according to claim 5, wherein
in the second processing, the processor causes the first processing to be executed after the predetermined period elapses from when the second resource amount is requested by the user application.

7. The information processing device according to claim 5, wherein
in the second processing, the processor:
determines whether a predetermined vehicle resource included in the vehicle is allocated for execution of an other application until the predetermined period elapses from when the second resource amount is requested by the user application;
when the predetermined vehicle resource is determined to be allocated for execution of the other application, does not cause the first processing to be executed until the predetermined period elapses from when the second resource amount is requested by the user application; and
when the predetermined vehicle resource is determined not to be allocated for execution of the other application, causes the first processing to be executed using the predetermined vehicle resource.

8. The information processing device according to claim 5, wherein
in calculating the predetermined period, the processor calculates the predetermined period, based on the first resource amount per unit time, the second resource amount, and the predetermined resource amount per unit time.

9. The information processing device according to claim 1, wherein
the processor:
obtains state information indicating a state of the vehicle; and
in determining whether the total resource amount is greater than the predetermined resource amount, uses, as the predetermined resource amount, a resource amount corresponding to the state of the vehicle indicated by the state information among a plurality of resource amounts specified in advance for a plurality of states of the vehicle.

10. The information processing device according to claim 9, wherein
the state information includes at least one of information indicating whether the vehicle is traveling or information indicating whether the vehicle is parked.

11. The information processing device according to claim 1, wherein
the user application is an application different from a basic application preinstalled in the vehicle.

12. An information processing method to be executed by an information processing device provided to a vehicle, the information processing method comprising:
determining whether a total resource amount that is a sum of a first resource amount and a second resource amount is greater than a predetermined resource amount, the first resource amount being a resource amount allocated to a user application being executed in the vehicle, the second resource amount being a resource amount requested by the user application being executed, the predetermined resource amount being a resource amount specified for the user application; and
executing predetermined processing, based on a determination result of whether the total resource amount is greater than the predetermined resource amount.

13. A non-transitory computer-readable recording medium having recorded thereon a program for causing a computer to execute the information processing method according to claim 12.
